(19) United States
(12) Patent Application Publication
(10) Pub. No.: US 2011/0119230 A1
(43) Pub. Date: May 19, 2011

(54) Method for automatically associating contacts in an online social network

(76) Inventor: Thomas Zuber, Los Angeles, CA (US)

(21) Appl. No.: 13/023,461

(22) Filed: Feb. 8, 2011

Related U.S. Application Data
(63) Continuation-in-part of application No. 12/575,442, filed on Oct. 7, 2009.
(60) Provisional application No. 61/460,333, filed on Dec. 31, 2010.

(51) Int. Cl. G06F 17/30

(52) U.S. Cl. 707/608; 707/E17.008

(57) ABSTRACT

A method for creating and managing contact information in the context of an online social networking community. Each member of the social networking community creates a member profile containing contact information such as email address, telephone numbers, and street addresses. When a member joins a subgroup or secure network within the social networking community, the member's profile is shared with all other members of that secure network. The member's own contacts are also shared with all other members of the network such that one member of the network has access to all contacts of every other member of the network. Contact profiles are automatically updated as the owner of the profile provides new information to his or her profile. Duplicate entries are minimized by a matching feature that alerts members to the creation of possible duplicates and allows the members to merge, delete, or or ignore potential duplicate profiles. Members of a secure network who have shared contact profiles in this manner are able to collaborate on documents and projects within the context of the online social networking community.

### CROSS REFERENCE TO RELATED APPLICATIONS

This application claims the benefit under 35 U.S.C. 119(e) to U.S. Provisional Patent Application Ser. No. 61/460,333, filed Dec. 31, 2010, entitled “Method for automatically associating contacts in an online social network.” This application claims benefit as a Continuation-In-Part under 35 U.S.C. §120 to U.S. patent application Ser. No. 12/575,442, filed Oct. 7, 2009, titled “System and method for interactively collaborating within a secure online social networking community.” This application is related to commonly-owned U.S. patent application Ser. No. 12/493,096, filed Jun. 26, 2009, U.S. Provisional Patent Application No. 61/210,627, filed Mar. 20, 2009, U.S. patent application Ser. No. 12/885,325, filed Sep. 17, 2010, U.S. Provisional Patent Application No. 61/455,985, filed Oct. 29, 2010, and U.S. patent application Ser. No. 13/011,655, filed Jan. 21, 2011. The contents of each of these patent applications are incorporated herein in their entirety by reference.

### STATEMENT REGARDING FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to systems and methods for interactive collaboration within a secure, online social networking community integrated with a document management system and made up of virtual identities enabled with multiple social networking functionalities, document management functionalities, and integrative functionalities. More particularly, the invention described here related to methods for automatically associating and organizing personal contact information in the context of a secure, online social networking community. Members of the online social networking community each have one or more member profiles containing information about the member such as name, home and business addresses, telephone numbers, email address, personal information, photos, links to communicate with members owning member profiles and other information as provided by the member and as allowed by the community.

Social networking web sites, such as Facebook.com and MySpace.com, are communities of persons having virtual identities enabled with social networking functionalities. Such sites are often geared towards users having special recreational or social interests such as baseball games, motorcycle riding or. dating. There are also social networking web sites for professionals—for example, LinkedIn.com, EsqChat.com and LegallyMinded.com—and some of these sites are communities of persons having virtual identities enabled with social networking functionalities. However such social networking web sites do not include integration of the member profiles and contacts in a way that allows members of discrete network within the social networking website to take advantage of their shared resources. It is this missing integration which provides synergies that facilitate viral online growth, as well as the foundation for the conception and creation of integration functionalities that facilitate business networking, operations and transactions.

In the first place, such social networking web sites exist independently of the members contact organizer or electronic rolodex. Examples of a contact organizer would be those found in Microsoft Outlook, Mac OS X Mail and Address Book, Google Gmail, and similar programs and services. In each, the contacts are contained within or associated only with the mail client or address book itself, and are not easily shared among the social networking members friends and contacts. What information is shareable in the context of a social networking website is usually of a very limited nature, such as the member name, usually in the context of a “friend of a friend” manner, or “people you may know” notification which allows the member to add each contact one at a time to the social networking friends list of the member.

Contact file management systems disclosed in the prior art, such as Outlook®, allow the management of contact files, each of which contain contact information that may be imported into document management systems and word processing applications like Word®. However, in regard to a particular person, contact file management systems like Outlook® require each of tens or hundreds or even thousands of contacts of the particular person to create, maintain and/or update a contact file corresponding to the person. Software applications like Plaxo® facilitate the process of allowing each of many contacts of a single person to more easily update contact information of the single person. However, Outlook® and Plaxo® each (and collectively) have it backwards, so to speak, in that they require many contacts of a single person to collectively create, maintain, and/or update many contact files each corresponding to the single person. Thus, there is need for an invention that allows the single person to maintain a single contact file, which single contact file could be accessed by all of the contacts of the single person, the contact information of which single contact file is importable into document management systems and word processing applications of each of the contacts.

In the context of existing social networking sites, a member is allowed to add another member of the site as a “friend” or “contact.” Generally this is done by the first member asking to be added to the other member's friend list. The second member then accepts (or declines) and the new contact is created in the context of the social networking website. This model is followed one contact at a time until the member's contact list is built up in the context of that social networking website. Thus, even if the member is already well-acquainted with another member of the social networking website or community, that member is obliged to re-create from scratch his pool of contacts in the context of each social networking website.

Moreover, the addition of a new friend or contact in existing social networking communities adds very little in the way of integrative functionalities available to the member. For example, in the case of the social networking site LinkedIn.com, the member can open his contact list and can click on a contact's email address displayed within the website, which then activates the member's email client (such as Outlook) for drafting an email. Alternatively, the user may choose to download a v-card, which is then used to save the contact's information in Outlook or a similar program. Continuing with the example, LinkedIn.com also allows members to communicate with other members (through electronic messaging, for example); but does not allow merging contact files stored in Outlook or an electronic rolodex with the profile of the social network user. Finally, the current state of the art does not allow the member to easily share his own contacts with other members of his organization.”

Yet another problem with the current state of the art is the creation of duplicate or conflicting entries when contacts are pooled or shared within an organization. In this context, it is difficult to determine which is the appropriate contact information to use for a given contact. This situation also creates difficulty associated with artificial bloating of contact lists within an organization or network.

The prior art also lacks a means to allow a user to efficiently and automatically integrate and share a pool of contacts in the context of an online social networking site into the email client or address book, and to efficiently and automatically make documents available for collaboration between contacts within a document management system. The prior art also lacks a means to automatically update the stored contact information when the contact information changes.

Thus there remains a need for a document management system and contact management system integrated into a truly cooperative community of virtual identities that enable a plurality of social networking functionalities. There furthermore remains a need for the synergies that will result from such integration to fuel the viral growth of such online communities. Finally, there remains a need for the integrative functionalities, the creation of which is conceivable and made possible in the context of such integration, which integrative functionalities will facilitate business networking, operations and transactions, and allow cloud computing portals for document management systems to more fully tap the viral power of the internet as enabled by social networking functionalities.

There exists, then, a need for a method and system which allows the user to integrate and automatically manage and share contacts in the context of an online social network. It is the object of the present invention to provide a system where a user's social network contacts are automatically integrated into the user's address book, and whereby contact information known to one user is automatically made available to other users within a discrete network.

### BRIEF SUMMARY OF THE INVENTION

The future of web-based computing is rapidly taking shape. Emerging trends include such concepts as cloud computing and Web 2.0, in which a web or cloud-based infrastructure designed for rapid delivery of computing resources is made available through either a public or private provider. While many definitions of these concepts exist, the next generation of computing architecture will focus on delivering business and consumer services with a user focus, designed to encourage rapid innovation and efficient, collaborative decision making. Many market participants are actively trying to develop a dominant online portal for cloud computing, although none has yet done so.

The present invention describes an integration of cloud computing-based services through a portal that combines social networking functionalities with document management and contact management system functionalities, further enhanced with integrative functionalities as described herein.

The present invention discloses a secure, network-based collaborative work environment in which one or members of an online community having virtual identities enabled with social networking functionalities and document management functionalities are able to access and utilize a variety of integrative functionalities as fully described herein. The integrative functionalities include, but are not limited to:

clicking on an icon on a virtual identity existing in the context of a social networking website and thereby giving the person associated with such virtual identity access to (or retracting access of the person associated with such virtual identity to) a secure set of documents shared by a network that at least some persons associated with virtual identities do not have access to;

clicking on an icon on a virtual identity existing in the context of a social networking website and thereby giving the person associated with such virtual identity access to (or retracting access of the person associated with such virtual identity to) a pool of contacts shared by a network that at least some persons associated with virtual identities do not have access to;

sharing access to a secure pool of contact information, such that members not owning social networking member profiles belonging to the network do not have access to the pool of contact information;

having software applications that import contact information from member virtual identities, thereby allowing to auto-fill of contact information in the context of document drafting, mail merge applications in the context of mass distributions, etc. (e.g.: thereby effectively eliminating the need to obtain a new business acquaintance's business card, create a new contact file (i.e.: in a contact file management program like Outlook®) containing the new business acquaintance's contact information, or the need to ever update such contact file—just add the business acquaintance's member virtual identity, which will contain contact information updated by the business acquaintance himself/herself); and furthermore allowing members of a network of members to share a pool of virtual identity contacts, such that members not of the at least one network of members do not have access to the pool of virtual identity contacts;

Other features and advantages of the present invention will become more apparent from the following description of the embodiments, taken together with the accompanying several views of the drawings, which illustrate, by way of example, the principles of the invention.

### BRIEF DESCRIPTION OF THE DRAWINGS

FIG. 1 is a conceptual diagram of a system and method of providing an online social community with integrative functionalities according to one embodiment of the present invention;

FIG. 2 is an exemplary graphical implementation of one aspect of the present invention showing a member's virtual identity and having several integrative functionalities accessible;

FIG. 3 is an exemplary graphical implementation of another aspect of the present invention showing multiple views of a document management system;

FIG. 4 is an exemplary implementation of another aspect of the present invention showing information on a member's virtual identity and implementation of integrative functionalities therein;

FIG. 5 is an exemplary graphical implementation of another aspect of the present invention showing a home page;

FIG. 6 is an exemplary graphical implementation of another aspect of the present invention showing a member profile;

FIG. 7 is an exemplary graphical implementation of another aspect of the present invention showing a member profile as viewed by members who are not contacts;

FIG. 8 is an exemplary graphical implementation of another aspect of the present invention showing a member profile of a second members as viewed by an owner;

FIG. 9 is an exemplary graphical implementation of another aspect of the present invention showing a member profile as viewed by members who are contacts;

FIG. 10 is an exemplary graphical implementation of another aspect of the present invention showing lists of contacts;

FIG. 11 is an exemplary graphical implementation of another aspect of the present invention showing lists of links to network profiles;

FIG. 12 is an exemplary graphical implementation of another aspect of the present invention showing a network profile;

FIG. 13 is an exemplary graphical implementation of another aspect of the present invention showing a document management tool with a document filing tool and email tool active;

FIG. 14 is an exemplary graphical implementation of another aspect of the present invention showing a document management tool with a document filing tool and word processor tool active;

FIG. 15 is an exemplary graphical implementation of another aspect of the present invention showing a document management tool with a document filing tool and spreadsheet tool active;

FIG. 16 is an exemplary graphical implementation of another aspect of the present invention showing a document management tool with a document filing tool and presentation tool active;

FIG. 17 is an exemplary graphical implementation of another aspect of the present invention showing a document management tool with a document filing tool and image viewing tool active;

FIG. 18 is an exemplary graphical implementation of another aspect of the present invention showing a document management tool with a document filing tool and word processor tool active in a multi-column format; and

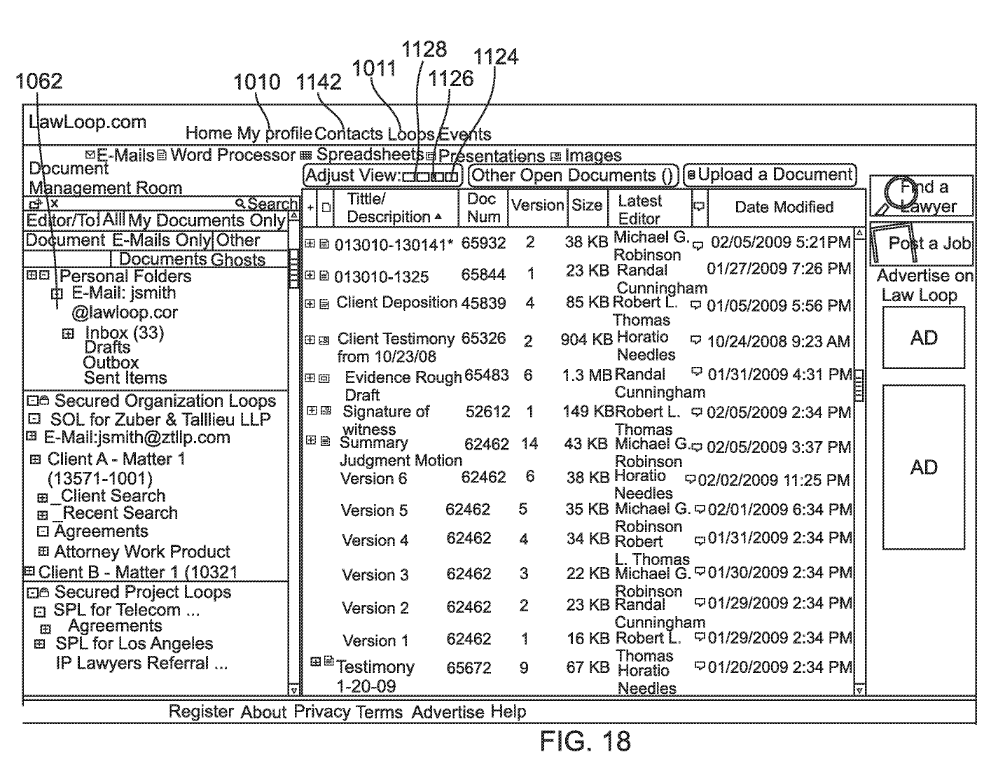

FIG. 19 is an exemplary graphical implementation of another aspect of the present invention showing lists of shared contacts.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

Without limiting the generality of the foregoing, some of the descriptions and examples below and in the inventions described by the inventor in U.S. patent application Ser. Nos. 12/525,442 and 12/493,096, both incorporated herein in their entirety by reference, and in U.S. Provisional Patent Application Nos. 61/210,627, and 61/455,985, both incorporated herein in their entirety by reference, relate to law firms, and to attorneys, staff persons and clients of law firms, as a matter of convenience, and for the sake of illustration, only; and the present invention may be utilized and practice by other organizations, professionals, entities and/or persons, and such use and practice is contemplated by and included within the scope of the present invention.

### DETAILED DESCRIPTION OF THE INVENTION AND EMBODIMENTS AS CLAIMED

The present invention discloses an online social networking community. More particularly, the present invention discloses a system and method for automatically sharing and associating contacts in an online social networking community. The present invention further discloses integrative functionalities which lie on top of, and are made possible by, combining social networking functionalities with contact management and document management functionalities, within a remote, secure online environment.

Members of the online social networking community have an account with the online community which defines a member virtual identity associated with the member. The member virtual identity typically includes web pages that convey information about the member to one or more other members of the community, is enabled with one or more social networking functionalities, and is an online representation of that member that may take many different forms. In regard to each member, participation in the online community typically requires identification verification in order to enable the member's member virtual identity, and therefore means of identifying a member, such as a username, a password, fingerprints, or some other form of identification means relating an identity of a member to his or her member virtual identity, may also be included within the member virtual identity so that a member entering such information can be verified as the owner of the member virtual identity. The member virtual identity allows members to participate in at least one social functionality available within the online community.

Alternatively, the member virtual identity may be represented by an icon (“icon” meaning a graphical link, textual link, or other link to a web page or a location on a web page) instead of web pages. Typically, though, a member virtual identity will consist simply of a login account of the relevant member, a web page or a collection of web pages associated with the member (which typically include/s a profile (defined below) of the member and may or may not include additional web pages), and at least one social networking functionality (defined below).

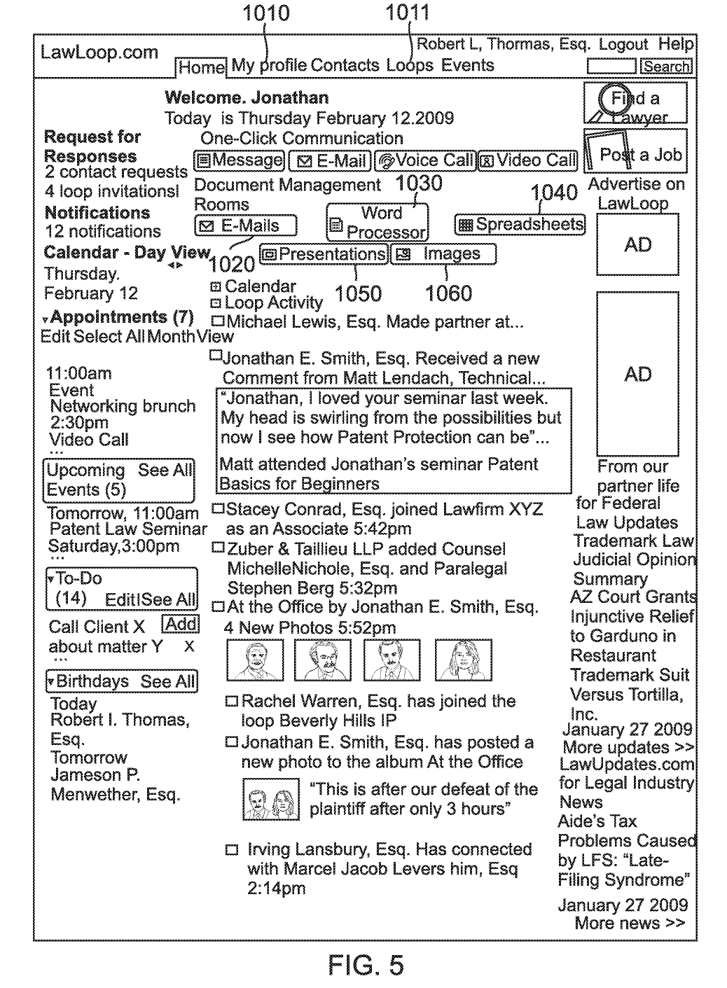

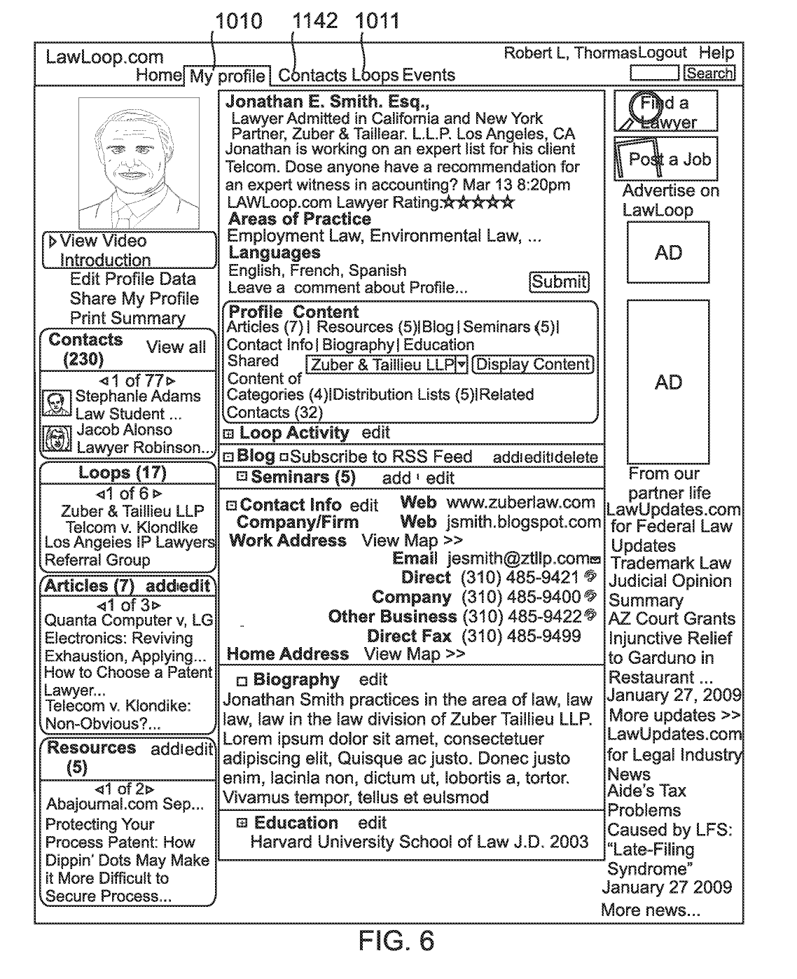

For example, a first member may access his/her member virtual identity by typing in a username and password at a login web page, as a user of social networking websites such as Facebook.com, Myspace.com or LinkedIn.com enters a username and password at a login web page to access his/her member virtual identity. Upon doing so, the web pages of the member's virtual identity appear, starting with a home page such as the web page depicted at FIG. 5 (also referred to herein as “Home Page”) to appear. The member may access his/her profile (profile of a member or “member profile” meaning the web pages of a member's virtual identity that are partially or wholly visible to one or more other members of the community, often including contact information of the member, such as but not limited to business address, home address, business phone number, home phone number, mobile phone number, business fax number, home fax number, email address, etc., as the term “profile” is commonly understood in the online social networking industry) by clicking on the “My Profile” link at 1010, causing a web page of the profile such as the web page depicted at FIG. 6 (also referred to herein as “Profile—View By Owner,” where “owner” means the first member referenced above to whom the member virtual identity corresponds) to appear. Profile—View By Owner (FIG. 6) can differ from the versions of the Profile that are visible to one or more other members (i.e.: other than the Owner).

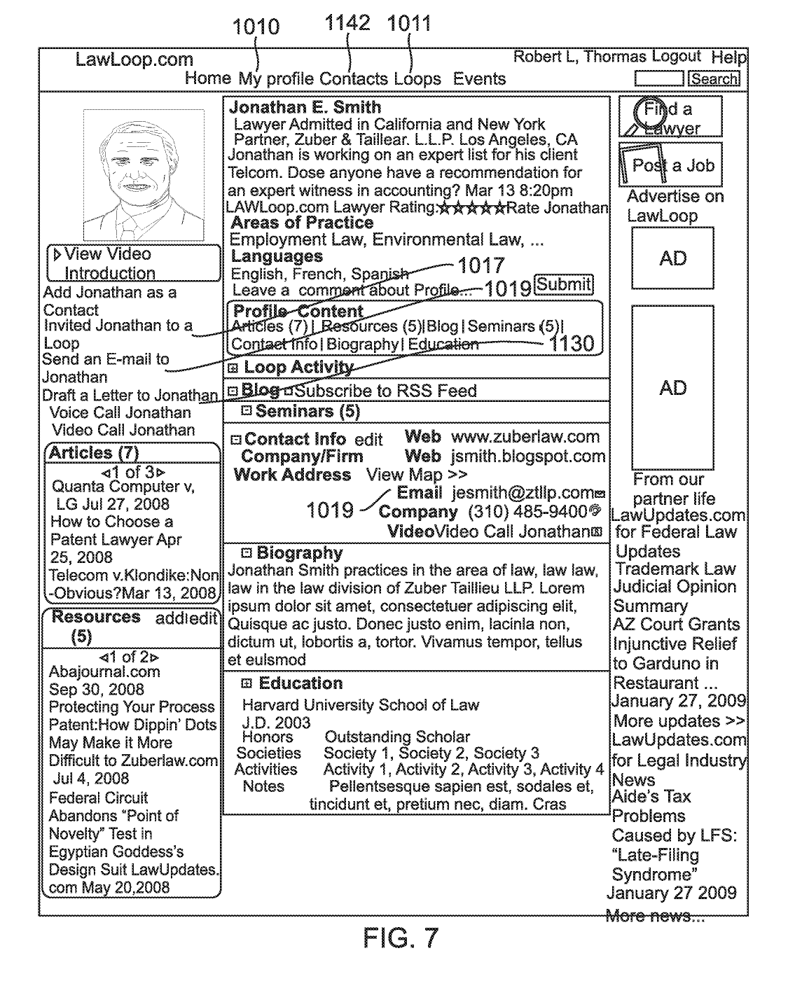

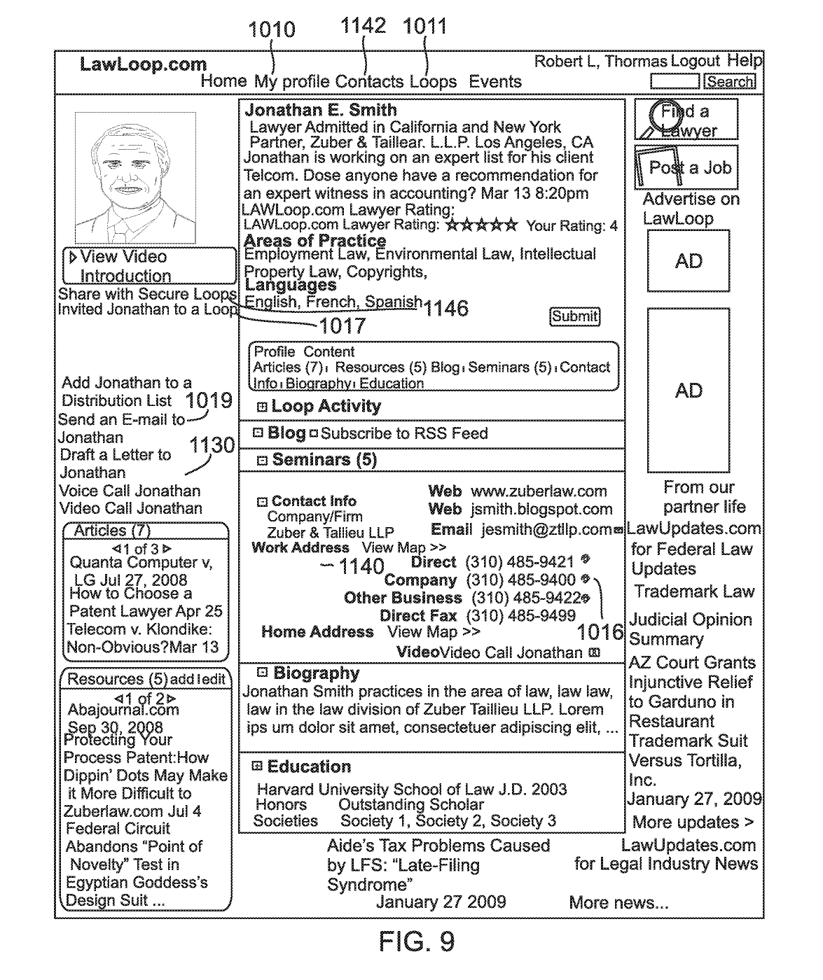

For example, members other than the owner who have not been added as contacts (“contact” having a meaning analogous to “friend” on Facebook.com or Myspace.com, or to “connection” on LinkedIn.com, as the term “contact” is commonly understood in the online social networking industry) may see the version of the profile depicted at FIG. 7 (also referred to herein as “Profile—View by Members Who Are Not Contacts”), which might differ from Profile—View By Owner (FIG. 6), for example, in that Profile—View By Owner (FIG. 6) can include links that allow the owner to add, delete or edit content on his/her profile, and that the web page depicted in FIG. 9 (also referred to herein as “Profile—View by Members Who Are Contacts”) might not; and in that Profile—View by Members Who Are Contacts (FIG. 9) may include an “Add Jonathan as a Contact” link, while the Profile—View By Owner (FIG. 6) might not.

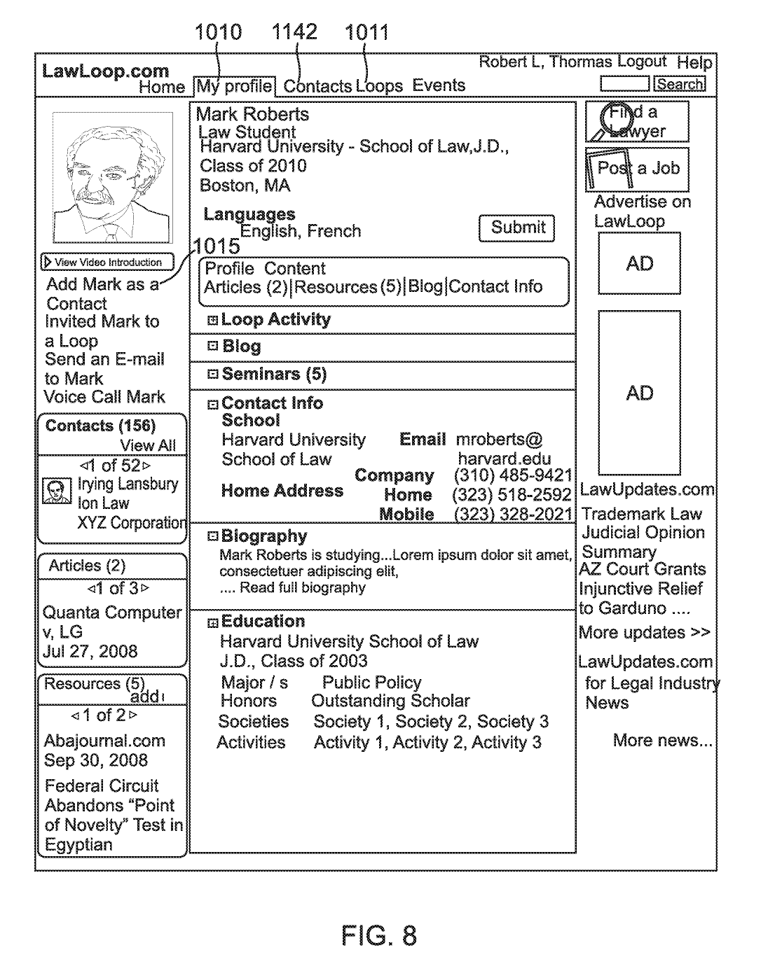

The member, being a first member, may add a second member as a contact, whereby the second member would be a contact of the first member (and vice versa), such that, for example, the first member could view additional and/or alternative web pages and/or information (e.g.: which additional and/or alternative web pages and/or information are created and selected by the second member in accordance with methods disclosed and enabled in the prior art, which disclosures are incorporated herein by reference) of/on the second member's profile (and vice versa, respectively), for example, by clicking on the “Add Mark as a Contact” link 1015 on the profile of the second member depicted at FIG. 8 (also referred to herein as “Member Profile of Second Member—Viewed By Owner”), and thereby delivering a message (e.g.: via email, electronic message, instant message, or another social networking functionality of the community) to the second member allowing the second member to “accept” the request (i.e.: to effect the add and thereby make the requestor a member of the network), for example, by clicking on a link within the message.

Having been added as a contact by the first member, the second member could see the version of the profile depicted at FIG. 9 (Profile—View by Members Who Are Contacts), which may differ from Profile—View By Members Who Are Not Contacts (FIG. 7), for example, in that Profile—View by Members Who Are Contacts (FIG. 9) can include additional contact information 1016 that is not included in the Profile—View by Members Who Are Not Contacts as shown in FIG. 7.

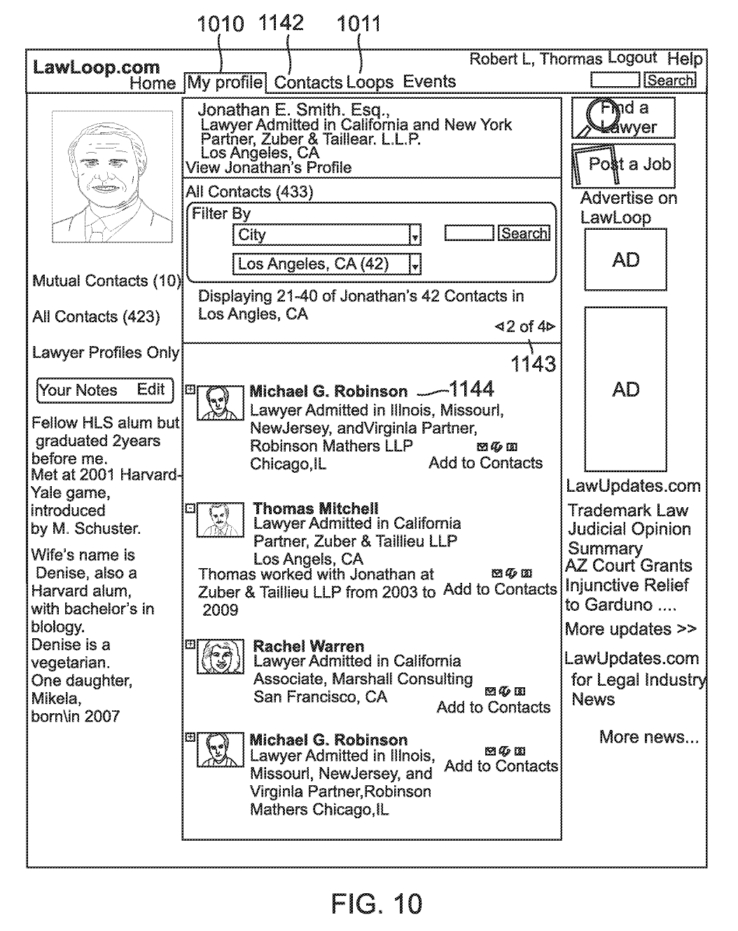

Furthermore, the first member, having logged in via the login account of his/her own virtual identity and accessed his/her own profile, could click on an icon 1142 of his own profile depicted in FIG. 6, thereby causing a web page depicted at FIG. 10 (also referred to herein as “Lists of Contacts”) displaying a list of links to the profiles of all contacts of the second member to appear, which links could be listed in alphabetical order based on the last name (or first name) of the contacts corresponding to the links, or based on many other ranking criteria.

In an alternative embodiment, if links to all of the contacts do not appear on one web page (for example, if the links are for any reason too numerous to appear on one web page), the member may browse additional lists of contacts by clicking the icon 1143 on FIG. 10, causing in the instance of each such click a web page displaying a list of links to profiles of additional contacts to appear, with each subsequent list a continuation of the immediately preceding list. Of course, referencing the example of the previous paragraph, a link to the profile of the second member. would appear on this list or one of these lists, respectively. The first member can click on a link 1144 on FIG. 10, which link links to the profile of the contact corresponding to the link, thereby causing the profile to appear.

The member virtual identity may also(but does not necessarily) allow a member to include professional and/or personal expression within the online community. For example, a member's thoughts on a particular subject, a member's planned activities, or any other expressive or emotive action, may be conveyed via the member virtual identity. The professional and/or personal expression conveyed via the member virtual identity may be conveyed in the context of a social networking functionality or through any other means available in the online community.

Examples of member virtual identities are widespread in the prior art. For example, online representations consisting of a user's login account, and the user's associated web page/s, on social networking websites such as Facebook.com, Myspace.com and LinkedIn.com, are each member virtual identities for the purposes of the present invention.

The members of the online community are capable of assembling into networks and sub-networks. These networks allow members to come together interact with each other via the social networking functionalities. An important feature of the present invention is that networks may be exclusive to certain members but not others, so that networks exclude at least one member in the online community. This allows for a collaborative work environment that provides members with the ability to work together on projects, and to communicate with one another or share contact information, in situations where some members of the online community cannot or should not participate. For example, lawyers who are members and included with a network or sub-network in which they are working on a set of documents for a client or clients must know that they are not sharing confidential information with members who cannot have access to that confidential information. Therefore, this network or sub-network will exclude other members to protect the confidential nature of the collaboration among members of that network.

A network within the online community may also have a network virtual identity associated with the network. The network virtual identity typically includes web pages that convey information about the network to one or more members of the community, may or may not be enabled with one or more social networking functionalities, and is an online representation of that network that may take many different forms. Alternatively, the member virtual identity may be represented by an icon instead of web pages. Typically, though, a network virtual identity will consist simply of a web page or collection of web pages associated with the network (which typically include/s a profile of the network and may or may not include additional web pages), and a link to a member virtual profile of at least one member who is a member of the network.

The network virtual identity may also include on its web pages professional and/or personal expression of one or more members of the network, which may be visible only to members of the network, or may be visible to members of the online community as a whole. For example, a network member's thoughts on a particular subject, a member's planned activities, or any other expressive or emotive action, may be conveyed via the network virtual identity. The professional and/or personal expression of members of the network conveyed via the network virtual identity may be conveyed in the context of a social networking functionality or through any other means available in the online community.

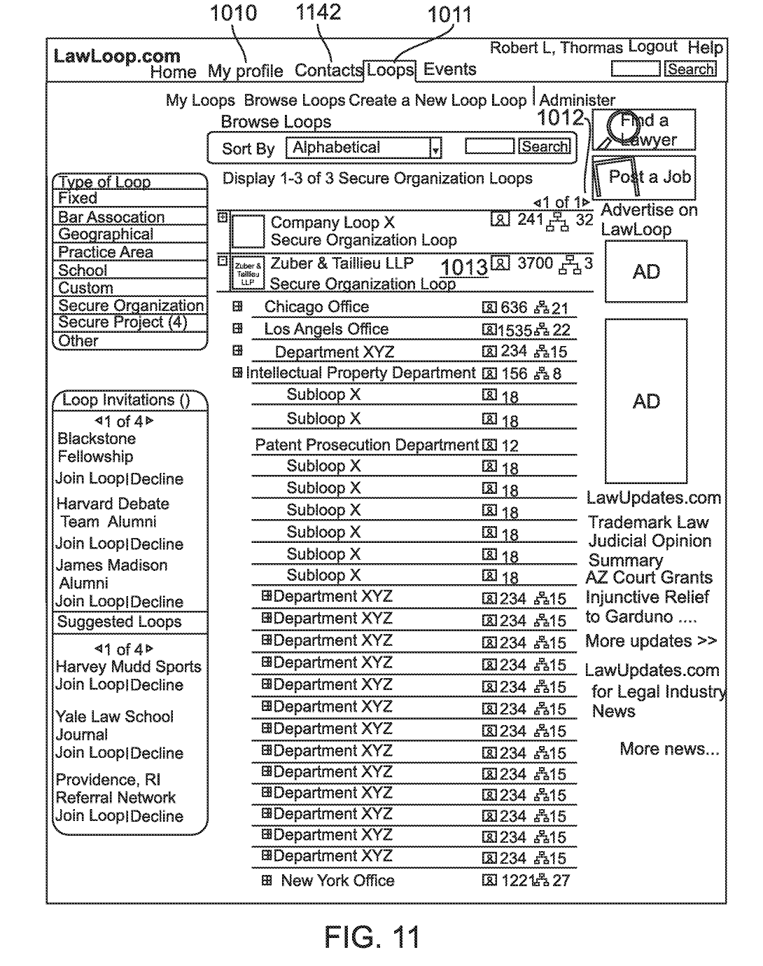

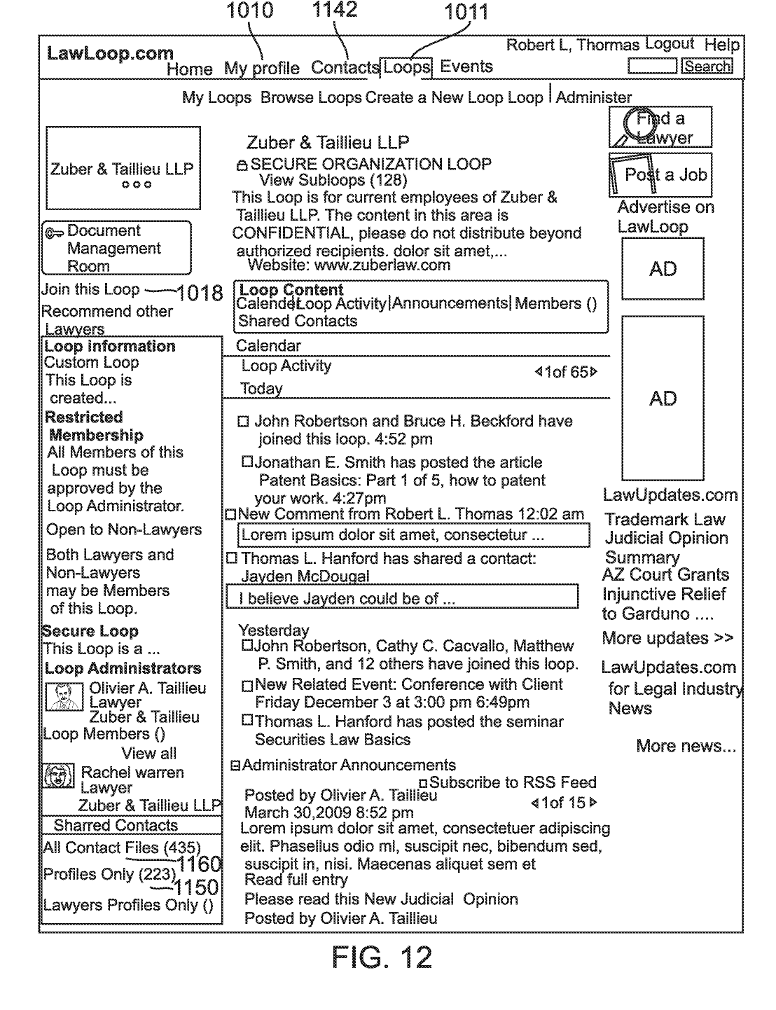

A member may browse network profiles (“profile” of a network or “network profile” meaning the web pages of a network's network virtual identity that are partially or wholly visible to one or more members network, or of the community as a whole, as the term “profile” is commonly understood in the online social networking industry) by clicking on the “Loops” link at 1011, causing a web page displaying a list of links to network profiles such as the web page depicted at FIG. 11 (also referred to herein as “List of Network Profiles”) to appear. The member may browse additional lists of network profiles by clicking the forward arrow at 1012, causing in the instance of each such click a web page displaying a list of links to additional network profiles to appear. The member may click on the network profile link at 1013 (“Link to Network Profile”), causing the network profile depicted at FIG. 12 (also referred to herein as “Network Profile”) to appear.

Typically, members of the network have rights to access and/or alter the network virtual identity that are greater than the rights of non-members, but not as great as the rights of a network administrator (i.e.: “network administrator” meaning any person or entity that may add and/or remove a member (i.e.: other than himself/herself/itself) from a network, as described below) of the network. For example, non-members of the network might be able to view a profile page of the network, but not be able to access other web pages of the network virtual identity, or to post professional and/or personal expression on the web pages the network virtual identity, or to add or delete members to or from, respectively, the network; members of the network might be able to access other web pages of the network virtual identity in addition to the profile page, and to post professional and/or personal expression on the web pages the network virtual identity, but not be able to add or delete members to or from, respectively, the network; while the network administrator of the network might be able to access all web pages of the network, to post professional and/or personal expression on the web pages of the network virtual identity, and to add or delete members to or from, respectively, the network. Of course, many other combinations of non-member, member, and network administrator rights are contemplated and within the scope of the present invention.

Members may assemble into a network based on a variety of characteristics and via a variety of methods. For example, a network administrator of a network may create and maintain a network, and may “add” members to the network (i.e.: incorporate members into the network), for example, referencing the example above, by clicking the “Invite Jonathan to a Loop” icon 1017 on the member virtual identity at FIG. 7. As another example, a network administrator of a network may invite a member to be added to the network, again referencing the example above, by clicking the “Invite Jonathan to a Loop” icon 1017 on the member virtual identity at FIG. 7, thereby delivering a message (e.g.: via email, electronic message, instant message, or another social networking functionality of the community) to the corresponding member allowing the member to “accept” the invitation (i.e.: to effect the add and thereby become a member of the network), for example, by clicking on a link within the message. As another example, a non-member of a network may request to join the network by clicking on an icon 1018 on the network virtual identity of the network at FIG. 12, thereby delivering a message (e.g.: via email, electronic message, instant message, or another social networking functionality of the community) to the network administrator of the network allowing the network administrator to “accept” the request (i.e.: to effect the add and thereby make the requestor a member of the network), for example, by clicking on a link within the message.

In each of the foregoing examples, verification of the identification of the member associated with the relevant member network identity may be confirmed prior to addition of the member to the network via delivery of a password (e.g.: via email, electronic message, instant message, or another social networking functionality of the community) by the member to the network administrator of the network, which password might be conveyed through means outside of the social networking community (e.g.: in person, via telephone, or via postal mail). The present invention also contemplates a reciprocal such exchange of passwords between the member and the network administrator to confirm (from the member's perspective) the identity of the network owning the network virtual identity that the member would be added to and to confirm (from the network administrator's perspective) the identity of the member owning the member virtual identity.

Exclusion from a network may be achieved in a variety of different ways. For example, exclusion from a network may be achieved by a network administrator's refusal to add a member to a network, refusal to accept a member's request to be added to the network, or “removal” of a member (i.e.: a revoking of a member's membership in the network) previously added to the network. Any other means of including or excluding members from participating in a network or sub-network are also contemplated by and included within the scope of the present invention. Of course, a member may also effect non-membership in the network by refusing to request addition to the network, refusing to accept an invitation to join the network by a network administrator of the network, or by removing himself/herself from the network.

Other social networking functionalities are also available to members in the online collaborative work environment. The social networking functionalities are available to members remotely (for instance, social networking functions enabled by software saved to servers remote from the members that allow members to manage virtual profiles and other web pages and aspects of the collaborative work environment saved on servers remote from the members). Examples of social networking functionalities include real-time communication functions that allow members (including, in particular, professionals who require communication functions in the course of collaborating within the present invention) to quickly and efficiently communicate with each other. These communication functions include, but are not limited to, on-line video conferencing, on-line voice conferencing, emailing, on-line messaging, instant messaging, text messaging, calendaring, and message posting. All of these occur in the context of the collaborative work environment and may occur within one or more networks, particularly where confidential information is being discussed and where one or members are excluded from the network.

Social networking functionalities may be accessed via a single click of an icon. Icons representative of social network functionalities may be found on a member virtual identity, on a network virtual identity, or both. A member may select a social networking functionality from his or her member virtual identity by clicking on an icon. For instance, a member may click on the icon 1019 on the member profile at FIG. 7 to initiate an email to Jonathan (which email could appear in a pop-up window, enabled by the Email Tool described below, in accordance with disclosures in the prior art, which disclosures are incorporated herein by reference). Note that the icon 1019 may appear in different forms on the same page, as shown in FIG. 7. Similarly, a member may select a social networking functionality from a network virtual identity of a network to which he or she is a member. Because member and network virtual identities have visual representations via a graphical user interface, members can navigate toward iconic representations of the social networking functionalities. Members may also access the social networking functionality via other methods, such as for example, via pull-down menus. Of course, other methods of accessing social networking functionalities are contemplated and within the scope of the present invention.

Specific examples of the use of social networking functionalities within the networks and sub-networks of members include the use of calendaring and message posting systems. Social networking functionalities may be shared among members within one network, but not shared among members of a sub-network, so that activities within a sub-network are not activities within the broader network. For example, one social networking functionality is a calendaring system. The present invention contemplates that one calendaring system (or, set of occurrences) may be used within a network. Within a sub-network of that network, a second calendaring system (or set of occurrences) may be used in which entirely different events are used. Calendar events may include dates, notices, deadlines, appointments, meetings, or any scheduled occurrence. Therefore, an event in the sub-network may not be included in the main network, so that the two calendaring systems include different dates and events. Members of a network may therefore “break off” to assemble in a sub-network and calendar different events that do not have utility in the main network. It is important to note that the sub-network may exclude a member of the network of members and that calendared dates in the sub-network may not be accessible to those excluded therefrom.

Similarly, a message posting system is a social networking functionality in which messages posted in one network (or sub-network) are not included in a first (or main) network. Members of a network may “break off” to assemble in a sub-network and post different messages that do not have utility in the main network and may not be viewable or accessible in the main network. It is important to note, as above, that the sub-network may exclude a member of the network of members and that posted messages in the sub-network may not be accessible to those excluded therefrom. Message may include any method of conveying a message, and may occur on any type of forum or medium.

Further social networking functionalities are also subject to the same principles, so that members of sub-networks can freely assemble to communicate and/or collaborate separate from a main network to which they are members, and can exclude members. Other examples include but are not limited to emailing systems, instant messaging systems, and video conferencing systems.

Other details, aspects and functions of social networking functionalities, including but not limited to those relating to the addition and removal of contacts, the creation and maintenance of online social networks by network administrators, and the addition and removal of members of online social networks, are thoroughly disclosed in the prior art, and these disclosures and are incorporated herein by reference.

In this context it is useful to define several of the terms used throughout the description of the invention. As used throughout this description, the term “Contact Profile” refers to a social networking member profile that has been added as a friend or contact as described above. Typically, a contact profile will be supplemented with additional information such as contact information not already provided as part of the contact profile. For example, a member may provide a work telephone number to all friends or contacts, while choosing not to share his own home telephone number. Once a contact profile is created, the first member may add the second member's home phone number to the contact profile. Similarly, one or more members of a network may contribute notes to the contact profile, or associate attachments or links corresponding to documents addressed to or received from the member owning the social networking member profile corresponding to the contact profile. In this manner, the contact profile is based on the member profile, but may be augmented or supplemented with additional information relevant to the contact.

By contrast, a “contact file” is not based on a social networking member profile, but is instead based on information created by a member about another member or non-member. For example, a member may wish to include information for “Bob Jones” in a shared pool of contacts. If Bob Jones is a member of the social networking community and has been added as a friend or contact of the first member, the contact information can be shared by using the contact profile as described immediately above. However, it will not always be the case that Bob Jones is a member of the social networking community, or it may be that Bob Jones does not wish to accept a friend request from the first member. In this case, the first member would contribute as much information as is known about Bob Jones to a “contact file” that could be shared with members of the network.

In determining whether a contact profile or contact file corresponds to a member of the social networking community, reference is made to the term “name.” As used herein, “name” refers to the name of the member owning a social networking member profile, typically cited as such on the social networking member profile itself. For example, “Jonathan E. Smith” is the name of the member profile in FIG. 6. In regard to a contact file, it refers to the name of the person to whom the contact file corresponds, typically cited as such on the contact file itself.

Document management functionalities are also available to members in the collaborative work environment. One example of a document management functionality is the ability to create documents (i.e.: “document” meaning an email, a word processing document (e.g.: a letter, a fax), a spreadsheet, a presentation (e.g.: a Power Point® presentation), an image (e.g.: an Adobe Acrobat® image, a digital photograph), or any other type of document as the term “document” is used in the software application industry). Another example of a document management functionality is the ability to edit documents. Other examples of a document management functionality are the ability to delete documents, to save documents, to organize documents, to file documents, to access documents, to send documents, to receive documents, and to share documents.

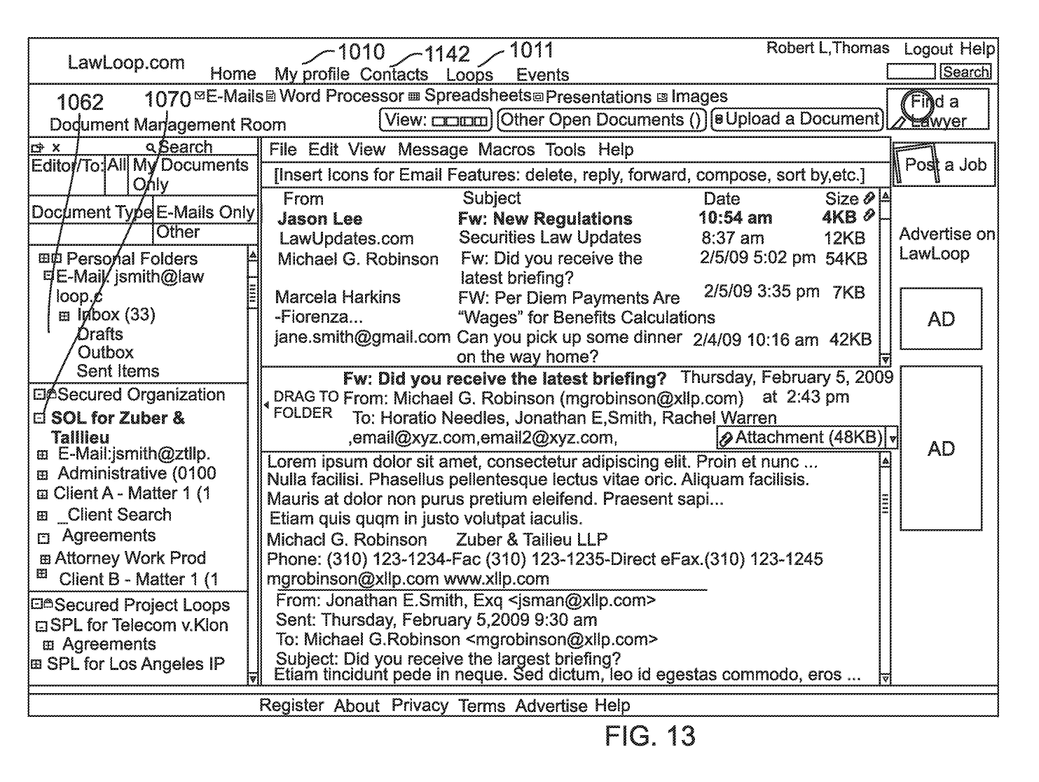

The document management functionalities are accessible to members via a document management tool that allows members to remotely and securely manage (i.e.: “manage” means to create, edit, delete, save, organize, file, access, send, receive, and/or share) documents. The document management tool comprises online software applications available to members that allow members to manage documents remotely (for instance, software applications saved on servers remote from the member that allow the members to manage documents saved on servers remote from the members), including a calendaring tool such as Outlook®, an email tool like Outlook® or Zoho® Mail, a word processing tool such as Word® or Zoho® Writer, a spread sheet tool such as Excel® or Zoho® Sheet, a presentation tool such as Power Point or Zoho® Show, an image viewing tool such as Adobe Acrobat®, a document filing tool like Interwoven® or Zoho® Docs, and/or a contact file management tool such as Outlook® (“contact file” meaning a file containing/storing contact information, but not being associated with a virtual identity, as such term “contact file” is commonly understood in the contact file management software application industry). The document management tool allows a member to access, work with, and manage a system of windows (i.e.: “window” meaning a portion of a computer monitor screen typically wholly or partially separated from other portions of the screen by a graphic border or other means) and folders for managing documents, such as the document management tool depicted at FIG. 13.

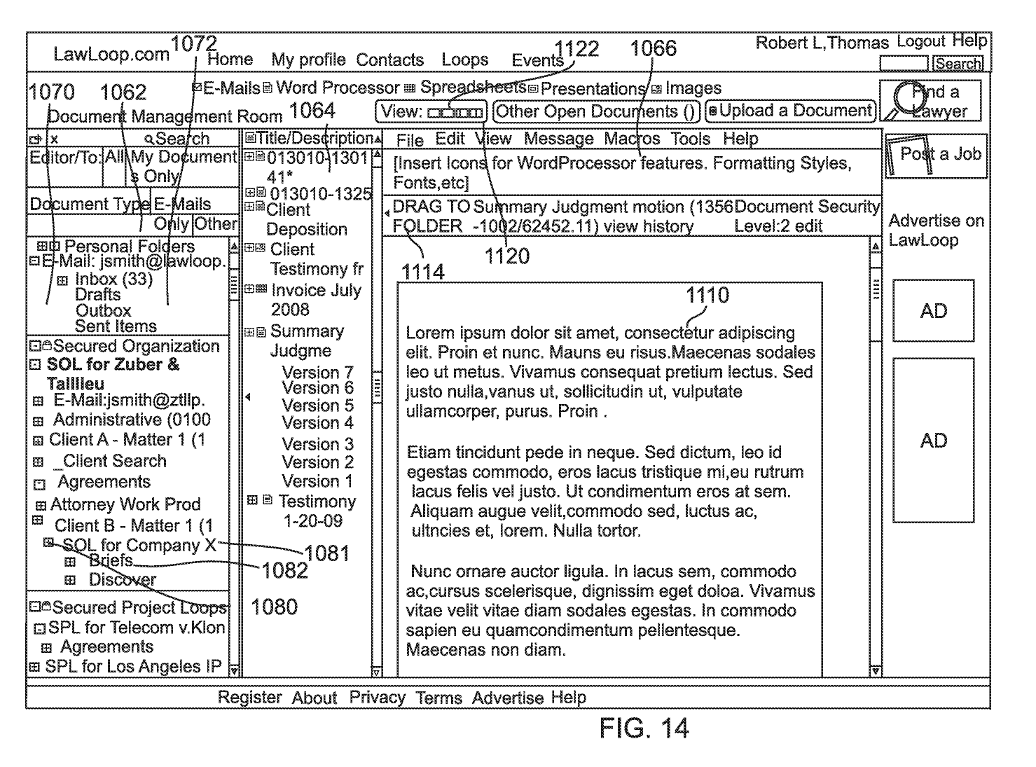

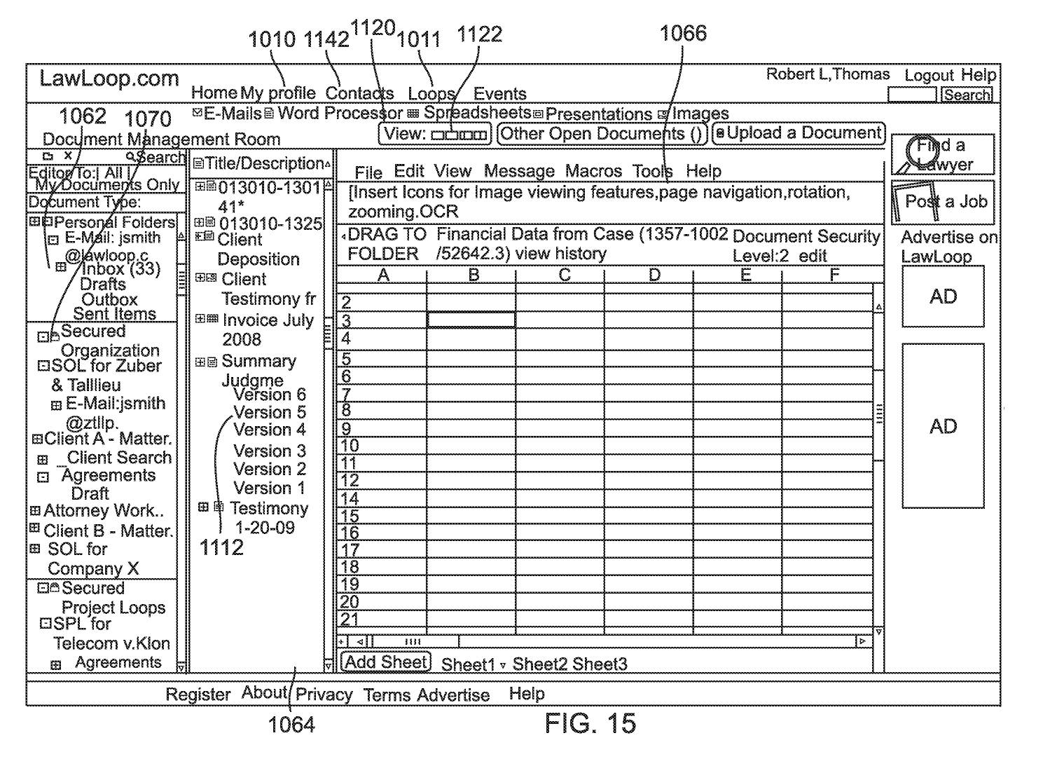

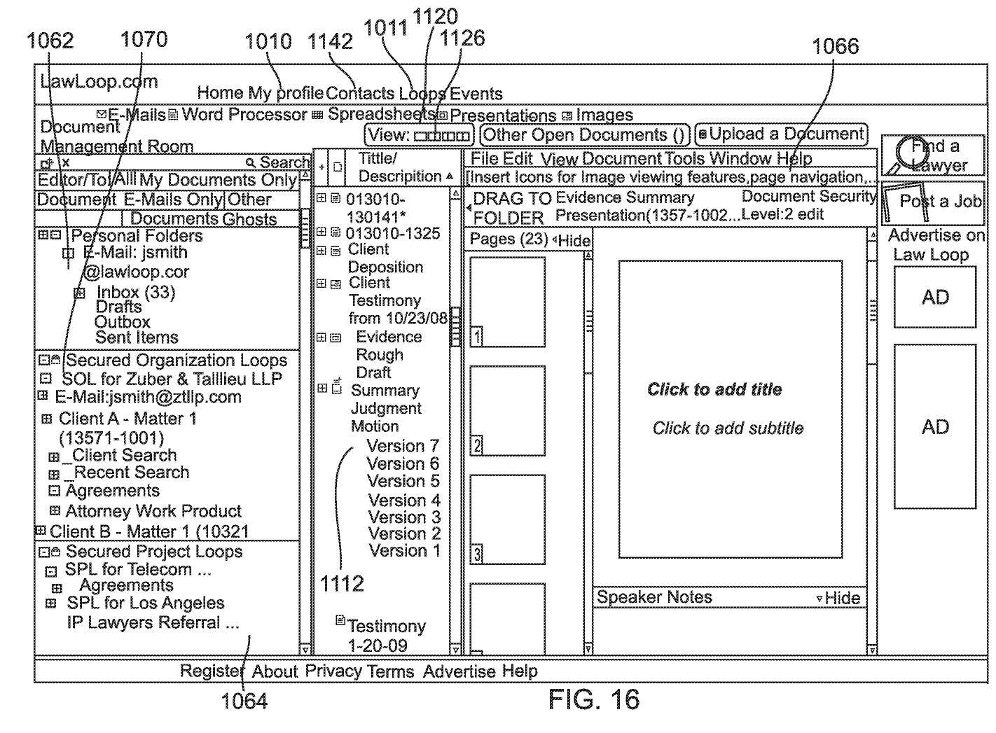

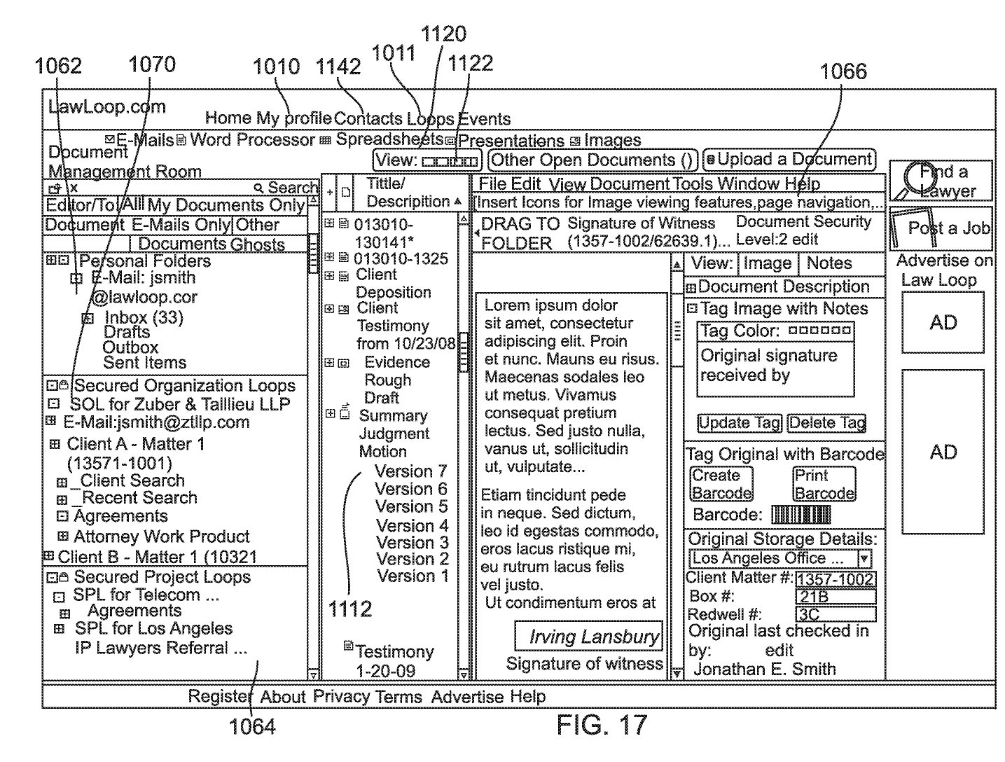

A member described in the example above who accessed his/her virtual identity by typing in a username and password at a login web page could access the document management tool from his/her Home Page by clicking on any of the link 1020, the link 1030, the link 1040, the link 1050 or the link 1060. For example, the member could click on the “Emails” link at 1020, causing a document management tool like the one depicted at FIG. 13, to become active, wherein a document filing tool and an email tool are active. As another example, the member could click on the “Word Processor” link 1030, causing a document management tool like the one depicted at FIG. 14, to become active, wherein a document filing tool and a word processing tool are active. As another example, the member could click on the “Spreadsheets” link 1040, causing a document management tool like the one depicted at FIG. 15, to become active, wherein a document filing tool and a spreadsheet tool are active. As another example, the member could click on the “Presentations” link 1050, causing a document management tool like the one depicted at FIG. 16, to become active, wherein a document filing tool and a presentation tool are active. As another example, the member could click on the “Images” link 1060, causing a document management tool like the one depicted at FIG. 17, to become active, wherein a document filing tool and an image viewing tool are active.

Other details and aspects of these document management functionalities, and these software applications, are thoroughly disclosed and enabled in the prior art, and these disclosures are incorporated herein by reference.

The online collaborative work environment of the present invention offers several integrative functionalities that overlay and are made possible by the combination of various social networking functionalities and document management functionalities. Integrative functionalities provide the mechanism for performing tasks within the collaborative work environment. These integrative functionalities allow members to collaborate within specific modules to work on projects together more easily, efficiently and effectively. Integrative functionalities allow members to manage (i.e.: “manage” meaning to create, edit, delete, save, organize, file, access, send, receive, and/or share) documents within a secure document management system more easily, efficiently and effectively. Among the integrative functionalities is the ability for members to easily assemble in a network remotely sharing a document or group of documents or a “room” (i.e.: “room” meaning a group of folders of documents, as the term “folder” is commonly understood in the industry in the context of document filing systems such as Interwoven®), typically stored on a server at a location remote from at least one (and typically most or all) of the members of the network. More particularly, a network administrator can create a network of members, each having member virtual identities, in accordance with the disclosures above, or in accordance with other means for forming networks on social networking websites such as Facebook.com, Myspace.com or LinkedIn.com. This integrative functionality of the present invention allows this network of members to easily, efficiently and securely share a room of folders of documents. For example, FIG. 14 shows a window 1062 displaying rooms of folders of documents including a room 1070 of folders of documents, which room 1070 is the folder 1072 and all of its subfolders, a window 1064 displaying links to documents stored in a folder 1100, which folder is stored in Room 1070 labeled “SOL of Zuber & Taillieu LLP,” and a window 1066 displaying the contents of document 1110 linked to by document link 1112. A member of the network may view the contents of any other document stored in folder 1100 by clicking the corresponding document link in window 1064, thereby causing the contents of the corresponding document to appear in window 1066. Similarly, a member of the network may view the contents of any other folder of room 1070 by clicking on the folder, thereby causing the document links to documents stored in the folder to appear in window 1064.

In one embodiment, the present invention contemplates a network of members comprising the attorneys and staff persons of a law firm, the network sharing a secure room 1070 of folders of documents of the law firm (i.e.: “secure” meaning that members and other persons who are not members of the network do not have access (or as complete access) to the room). Upon the hiring of a new attorney who is a member of the online social networking community, this integrative functionality allows the network administrator to grant the attorney the ability to use the document management functionalities described above to manage the room 1070 by simply adding the attorney to the network by, for example, simply clicking on an “Invite Jonathan to a Loop” icon 1017 on the attorney's member virtual identity at FIG. 7. Of course, this integrative functionality makes possible enormous efficiencies for the law firm. For example, referencing the foregoing example, the law firm added the newly hired attorney above without the need to incur the significant labor and capital costs typically associated with granting such a newly hired attorney access to, say, a secure server containing the documents shared by the law firm, such as, for example, the hours that it would have taken for technical personnel of the law firm to install on the attorney's computer the software applications required to allow the attorney to access the server and manage the documents. As another example, the law firm avoided the need to create a new login account for the newly hired attorney—rather, upon addition to the network, the newly hired attorney, by accessing the login account associated with his/her member virtual identity, has access to the online room 1070 shared by the network. Much as the receptionist at the entrance to the physical premises of the law firm recognizes the physicality of the attorney and grants him/her access to the physical premises, the network administrator recognizes the attorney's online member virtual identity, and grants the member virtual identity (and thereby the attorney) access to the online room 1070 shared by the network by simply adding the attorney to the network by, for example, simply clicking the “Invite Jonathan to a Loop” icon 1017 on the attorney's member virtual identity FIG. 7.

A further integrative functionality allows a member to share a first secure room of folders of documents with a first network of members and a second secure room of folders of documents with a second network of members with a single login account. For instance, referencing the example of the immediately preceding paragraph, the newly hired attorney who has been added to the law firm's network, being a first attorney, may be working on a litigation with a second attorney in the representation of a single client having a member virtual identity, and may wish to share one or more documents and/or folders with the second attorney having a member virtual identity and the client. Referencing FIG. 14, the law firm network being a first network, a second network administrator of a second network sharing a second secure room 1080 of folders of documents (i.e. which second secure room is (and which folders and documents therein are) not shared with members of the first network, or any other members, who are not members of the second network), which room 1080 is the folder and all of its subfolders, could add the first attorney, the second attorney and the client to the second network, thereby giving the first attorney, the second attorney and the client access to the second secure room of folders of documents. The first attorney, by accessing the login account of his/her member virtual identity, can, for example, manage document 1110, being a first document, of the first network by, for instance, accessing the documents of a folder 1100, being a first folder, shared by the first network and containing document 1110 by clicking'on folder 1100, then accessing the contents of document 1110 by clicking on document link 1112, and then editing or otherwise managing the document; and may similarly, for example, manage a second document shared by the second network by, for instance, clicking on a second folder 1082 of room 1080 containing the second document, thereby causing documents links to the documents stored in the second folder (again, which folder of room 1080 is shared by the second network and not by the first network) to appear in window 1064, clicking on the document link to the second document to cause the contents of the second document to appear in window 1066, and then editing or otherwise managing the second document (such clicking, accessing, editing and managing in each instance above in accordance with methods already disclosed and enabled in the prior art in the context of, for example, document filing tools such as Interwoven® and word processing tools such as Word® and Zoho Writer®, which disclosures are incorporated herein by reference).

A further integrative functionality is a member-virtual-identity-to-software-application contact-information-importation tool allowing members to import contact information from member profiles via their member virtual identities into the document management tool. For example, a second member could initiate a draft of a letter to a first member by clicking on an icon 1130 on the first member's profile as depicted in FIG. 9, thereby causing the word processor tool depicted in FIG. 14 to appear, except that no folder would be highlighted in window 1062 or window 1064, and window 1066 would contain a letter template addressed to the first member at mailing address 1140, the mailing address 1140 having been imported into the word processing tool, and into the new document, from the first member's profile.

A further integrative functionality is a member-virtual-identity-to-software-application contact-information-importation tool allowing a member to perform a mail merge (i.e.: “mail merge” meaning the production of multiple documents from a single template form and a structured data source, pursuant, for example, to pre-addressed letters, envelopes and/or mailing labels for mass mailings from a word processing document template which contains fixed text, that will be the same in each output document, and variables that act as placeholders that are replaced by text from the data source, as such term “mail merge” is commonly understood in the industry) with the word processor tool, whereby the word processor tool imports contact information from the profiles of the contacts of the member. Thus, the present invention effectively addresses the absurdity of requiring each of hundreds or thousands or more of contacts of a person to acquire, update, maintain, and ensure the accuracy of the person's contact information. Rather, using the present invention, all of the contacts of a member may access and utilize in the context of a document management tool contact information of a single contact file, in the form of the member's profile, maintained by the member, who is, of course, typically the person best able to update, maintain, and ensure the accuracy of his/her contact information.

### Contact Sharing

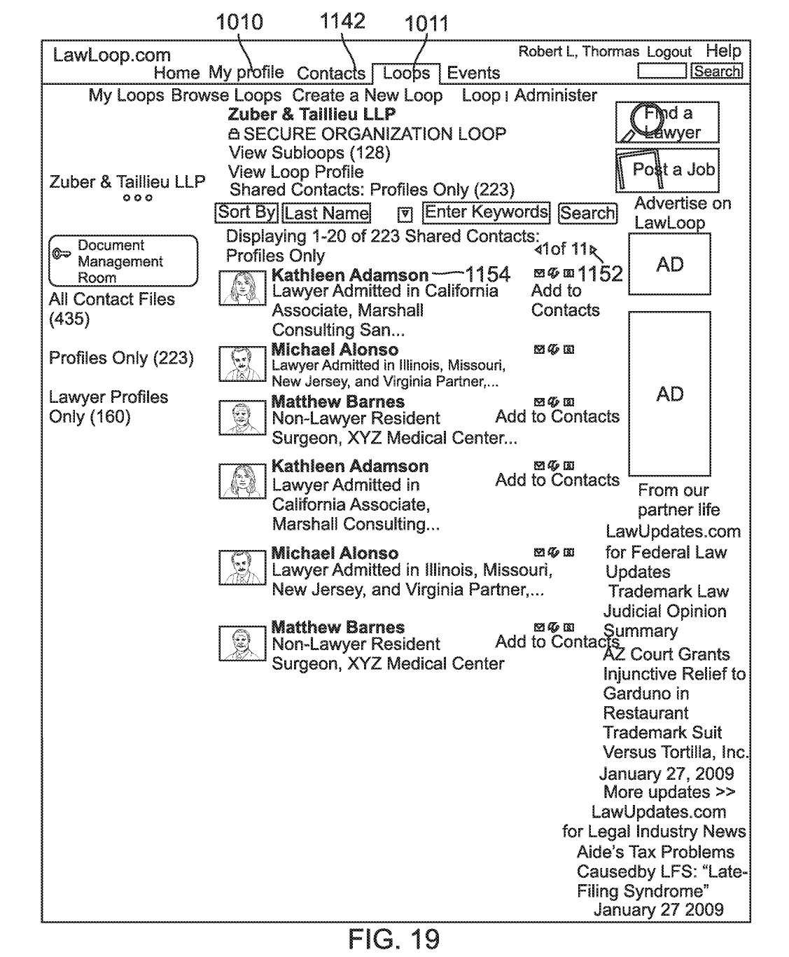

A further integrative functionality is a contacts sharing tool allowing members of a network to share a pool (i.e.: collection) of contacts, such that members not of the network of members do not have access to the pool of contacts. For example, in one embodiment, a member of a network could click on icon 1150 on a network profile depicted at FIG. 12 (which icon members not of said network would not be able to view or click), thereby causing a web page displaying a list of links to the profiles of all contacts of all members of the network, like the web page depicted at FIG. 19, to appear, which links could be listed in alphabetical order based on the last name (or first name) of the contacts corresponding to the links, or based on many other ranking criteria. If links to all of the contacts do not appear on one web page (for example, if the links are for any reason too numerous to appear on one web page), the member could browse additional lists of contacts of members of the network by clicking icon 1152 on FIG. 19, causing in the instance of each such click a web page displaying a list of links to profiles of additional contacts of the members of the network to appear, with each subsequent list a continuation of the immediately preceding list.

The member could click on a link 1154, thereby causing the contact profile of the contact corresponding to the link to appear. The member could use the member-virtual-identity-to-software-application contact-information-importation tool to initiate a draft of a letter to any contact in the pool of contacts by clicking on an icon on the profile of the contact, thereby importing contact information from the profile of the contact into the word processing tool and into the new document, as set forth above; or to perform a mail merge with the word processor tool, thereby causing the word processor tool to import contact information from the profiles of the contacts of the pool of contacts of the network, as set forth above.

As another example, in another embodiment of the present invention, each member of a network may select contacts to contribute to the pool of contacts shared by the members of the network. For example, a member could chose to contribute a contact of the member to the pool of contacts shared by the network by clicking on icon 1146 on the profile depicted in FIG. 9 corresponding to a contact of the member, thereby causing the contact to be contributed to the pool of contacts shared by the members of the network. In another embodiment of the present invention, a member of more than one network may click on icon 1146 on the profile depicted in FIG. 9 corresponding to a contact of the member, thereby causing a drop-down menu displaying a list of all of the networks of which the member is a member to appear, and the member could click on a network among the list, thereby causing the contact to be contributed to the pool of contacts of that network and not to the pool of contacts of other networks of which the member is a member. The member may view and browse the contacts of such shared pool of contacts of the network to which he/she contributed the contact by clicking on icon 1150 on the profile of the network, depicted at FIG. 12 (which icon members not of said network would not be able to view or click), thereby causing a web page displaying a list of links to the profiles of all contacts of all members of the network, like the web page depicted at FIG. 19, to appear, and then clicking on icon 1152 to view and browse through additional lists of links to profiles of contacts of the members of the network, and then click on a link 1154 to view the profile of the contact corresponding to the link to appear, all as set forth above in the preceding examples. The member may use the software application contact information importation tool to initiate a draft of a letter to any contact in the pool of contacts by clicking on an icon on the profile of the contact, thereby importing contact information from the profile of the contact into the word processing tool and into the new document, as set forth above; or to perform a mail merge with the word processor tool, thereby causing the word processor tool to import contact information from the profiles of the contacts of the pool of contacts of the network, as set forth above.

A further integrative functionality of the present invention allows members to use the contact file management tool to share and collectively manage contact files. Such contact file management, similar to that of the document management tool described above, allows members to share contact files online in a remote, secure environment. The present invention also allows for managing access to contact files within the inclusion/exclusion framework above, so that, for example, a member not belonging to a network of members does not have access to that network's pool of shared contact files. Typically, a contact file includes/stores contact information of a person, whether or not a member, such as but not limited to business addresses, home addresses, business phone numbers, home phone numbers, mobile phone numbers, business fax numbers, home fax numbers, email addresses, etc.

A further integrative functionality is a contact file sharing tool allowing members of a network to use the contact file management tool to share a pool (i.e.: collection) of contact files (i.e.: as opposed to contacts, as per the example above), such that members not of the network of members do not have access to the pool of contacts. For example, in one embodiment, a member of a network may click on icon 1160 on a network profile depicted at FIG. 12 (which icon members not of said network would not be able to view or click), thereby causing a web page displaying a list of links to the contact files of all members of the network, like the web page depicted at FIG. 19, to appear, which links could be listed in alphabetical order based on the last name (or first name) of the persons corresponding to the contact files corresponding to the links, or based on many other ranking criteria.

If links to all of the contact files do not appear on one web page (for example, if the links are for any reason too numerous to appear on one web page), the member may browse additional lists of contact files of members of the network by clicking icon 1152 on FIG. 19, causing in the instance of each such click a web page displaying a list of links to additional contact files of the members of the network to appear, with each subsequent list a continuation of the immediately preceding list. The member may click on a link 1154, thereby causing the contact file corresponding to the link to appear.

A member-virtual-identity-to-software-application contact-information-importation tool allows the automatic importation of contact information from a profile of a contact into a new created (i.e.: upon addition of the contact by the member) or existing contact file corresponding to the owner of the profile (i.e.: such that a business phone number cited on the profile is imported into a business phone number field in the contact file, a business address cited on the profile is imported into a business address field in the contact file, a mobile phone number cited on the profile is imported into a mobile phone number field on the contact file, an email address cited on the profile is imported into an email address field cited in the contact file, and so on for every type of contact information cited on the profile), such the a newly created contact file is completed or an existing contact file is updated, as relevant.

Furthermore, upon an updating of the profile by its owner, the member-virtual-identity-to-software-application contact-information-importation tool allows the automatic importation of updated contact information from the profile into the contact file, such that the contact file is automatically kept up to date without any further effort by the member. The member may initiate a draft of a letter to the person corresponding to any contact file in the pool of contact files by clicking on an icon on the contact file, thereby importing contact information from the contact file into the word processing tool and into the new document, as set forth above in regard to shared pools of contacts; or may perform a mail merge with the word processor tool, thereby causing the word processor tool to import contact information from the contact files of the pool of contact files of the network, as set forth above in regard to shared pools of contacts.

As another example, in another embodiment of the invention, each member of a network could select contact files to contribute to the pool of contact files shared by the members of the network. For example, a member may choose to contribute a contact file of the member to the pool of contact files shared by the network by clicking on an icon on the contact file, thereby causing the contact file to be contributed to the pool of contact files shared by the members of the network.

In another embodiment of the present invention, a member of more than one network may click on an icon on the contact file, thereby causing a drop-down menu displaying a list of all of the networks of which the member is a member to appear, and the member may click on a network among the list, thereby causing the contact file to be contributed to the pool of contact files of that network and not to the pool of contact files of other networks of which the member is a member. The member may view and browse the contact files of such shared pool of contact files of the network to which he/she contributed the contact file by clicking on icon 1160 on the profile of the network, depicted at FIG. 12 (which icon members not of said network would not be able to view or click), thereby causing a web page displaying a list of links to the contact files of all members of the network, like the web page depicted at FIG. 19, to appear, and then clicking on icon 1152 to view and browse through additional lists of links to contact files of the members of the network, and then click on a link 1154 to view the contact file corresponding to the link to appear, all as set forth above in the preceding examples.

A member-virtual-identity-to-software-application contact-information-importation tool allows the automatic importation of contact information from a profile of a contact into a new created (i.e.: upon addition of the contact by the member) or existing contact file corresponding to the owner of the profile, such the a newly created contact file is completed or an existing contact file is updated, as relevant. Furthermore, upon an updating of the profile by its owner, the member-virtual-identity-to-software-application contact-information-importation tool allows the automatic importation of updated contact information from the profile into the contact file, such that the contact file is automatically kept up to date without any further effort by the member.

The member may initiate a draft of a letter to the person corresponding to any contact file in the pool of contact files by clicking on an icon on the contact file, thereby importing contact information from the contact file into the word processing tool and into the new document, as set forth above in regard to shared pools of contacts; or could perform a mail merge with the word processor tool, thereby causing the word processor tool to import contact information from the contact files of the pool of contact files of the network, as set forth above in regard to shared pools of contacts.

It should be understood that to import one's contact information means to transfer or copy the information contained within a contact profile or a contact file from the contact profile or contact file, respectively, to another file or location or software application. This importation may involve copying an underlying file containing that contact information. Importation may also involve transferring contact information from any location and does not need to be from a contact profile or a contact file. For example, a member's or other person's contact information may be imported from an email tool or calendaring tool, or from a remote device such as a hard drive, a flash drive, or a phone.

It is also to be understood that contact files, and contact information contained therein, may be transferred or imported from one member virtual identity to another, and member virtual identities to network virtual identities and vice versa. Similarly, the contact file management tool is capable of transferring or importing a member's or network's entire contact list. The contact file management tool according to the present invention is therefore capable of managing a member's and a network's contact list, and does so while working with several contact applications.

Additionally, contacts can be imported using the click and drag method and can be accessed via an icon on a member virtual identity or network virtual identity. Contacts are therefore easily shared from member to member. For example, a member wishing to add another member's contact information clicks on that member's member virtual identity and drags it to his or her contact list. Other methods are also contemplated, such as importing via a pull-down menu, or right-clicking and selecting an import option. One can also access other contacts of a member and import their contact information by choosing an icon representative of their contact information and dragging to their member virtual identity profile as discussed above.

It is also an object of this invention to prevent the bloating of the pool of contact files and contact profiles by alerting members adding contact files or contact files to the existence of potential duplicate files. In one embodiment, a member who attempts to add to a pool a contact profile with a name matching the name of a contact profile already existing in the pool would be alerted by the social networking community to the existence of a “match” or potential duplicate entry. A “match” meaning that in the context of a first name on a first social networking member profile or a contact file and a second name on a second social networking member profile or contact file, the first name being identical or similar to the second name (whether or not the first social networking member profile or contact file actually corresponds to the same member as the second social networking member profile or contact file.) When a match is identified, the social networking community prevents duplicate contact profile(s) from being added to the pool of contact profiles and duplicate contact files from being added to the pool of contact profiles.

One method of preventing the creation of duplicate contact profiles or contact files is to alert a member that a first member is attempting to add a contact profile to the pool of contact profiles that matches a contact profile already existing in the pool of contact profiles or has a name that matches the name of a contact file already existing in the pool of contact files. Typically (but not always) the member who receives the alert is the member attempting to add the duplicate contact profile. A similar procedure is followed to prevent duplicate contact files when a member attempts to add a contact file matching a contact profile or contact file already in the pool of contacts.

In one embodiment of the invention, when a member is alerted to a match or potential duplicate, the alerted member is then presented with one or more options to deal with the potential duplicate contact profile. A first option is that the member may choose not to add the new contact profile. If this option is chosen, the existing contact profile remains unchanged and the new, un-added contact profile is deleted. In the context of deleting a contact profile from a pool of contacts or a contact file from a pool of contact files, “deleting” may mean merely hiding or deactivating the contact profile or contact file, such that the contact still exists, but is hidden from view and can be made visible later.

It the new contact profile is determined to actually correspond to the matched or already existing contact profile, the member has additional options. One option in this situation is that the member may choose not to add the new contact profile to the pool of contact profiles. In this case, though, non-superfluous information from the “new” contact profile will be used to supplement the existing contact profile. Another option is to add the new contact profile to the pool of contact profiles, but also supplementing the new contact profile with non-superfluous information from the already-existing contact profile. In yet another scenario, the new contact profile may correspond to an existing contact file. In this situation the member may choose to add the new contact profile to the pool of contact profiles and supplement the new contact profile with information from the contact file. Typically (but not invariably) the already existing contact profile or contact file will then be deleted (or hidden) from the pool of contact profiles. In any of these examples, the addition-supplementation-deletion actions may proceed in any order; for example, the member may choose to supplement the new profile with non-superfluous information and then delete the existing profile, or vice-versa.

Another option in this situation is for the member to choose to combine the new profile and the existing profile into a new hybrid entry containing information from the new and old profiles. In this situation, this third entry would typically be added to the pool of contact profiles and the first two contact profiles would be deleted.

Yet another option for the member alerted to the existence of a match or potential duplicate is to add the new contact profile to the pool of contact profiles without making any changes to the new profile or to any existing profiles. Typically, this option would be relevant when the match is a false positive. For example, if the new contact profile for Bob Jones was “matched” to a different person named Bob Jones. In this case, the member would want to keep the new contact profile and the existing contact profile or contact file.

It should be understood that the same procedure could be followed where a member attempts to add a new contact file that is determined to be a match with an existing contact profile or contact file in the network's pool of contact files or contact profiles.

It is also contemplated that a member for whom a contact file exists might also have a contact profile or a member profile within the network. For example, this situation might happen where a contact file is created for a vendor of a law firm. The vendor might later join the social networking community (thus creating his own profile) or the member-vendor might later be added as a contact profile by one or more members of the network. In this case, the member who created the contact profile might wish to supplement information in the contact file with information contained in the contact profile. Typically, the decision to supplement the contact file would occur upon termination of the vendor's last remaining friendship with other members of the network. This termination can happen either by direct termination of the last (or only) friendship the vendor has with a member of the network, or when the last friend of the vendor leaves the network. In this situation, other members still in the network might wish to retain contact information for the vendor. This is accomplished as described above by supplementing the vendor's contact file with information from the departing vendor's contact profile before the contact profile is removed from the pool of contact profiles. In another embodiment where no contact file exists for a departing vendor, a new contact file is created from the departing vendor's contact profile before the contact profile is removed from the pool of contact profiles. Although a vendor is used as an example in this situation, it is understood that this procedure applies to any member of the social networking community, such as co-workers, acquaintances, customers, and so on.

In yet another embodiment, members within a network may wish to share contact profiles and contact files with only certain other members of the network, while preventing certain other members of the network from having access to the contact profile or contact file. Thus, the description throughout this invention of “shared by the network” does not require that every piece of information shared with one member be shared with every other member of the network. As a practical example, the managing partner of a law firm may choose to share the contact profile for the CEO of a large client with other members of the law firms management committee, while keeping the CEO's contact profile hidden from the rest of the law firm. In this embodiment, the network administrator has the ability to limit access to the pool of contact profiles by at least one member of the network such that the member does not have access to at least one contact profile of the pool of contact profiles, while at least one other member of the network does have access to that contact profile.

Continuing with the example here, the managing partner may alternatively wish to share only portions of the CEO's contact profile with junior lawyers and staff of the law firm, while allowing members of the management committee to have full access to the profile. In this example, the junior lawyers and staff may be granted access to share only the CEO's email address, work address, and receptionist's phone number, while members of the management committee would be to share some greater subset of information, such as the CEO's cellular phone number or home address. In this embodiment, the network administrator has the ability to limit access to the information on a contact file of the pool of contact profiles by a member of the network such that the member does not have access to a portion of the information of the contact profile, wherein at least one other member of the network has access to the portion of the information.

Contact information imported from one file format or program is identified and categorized appropriately so that a member's contact information is accurately reflected after importation. For example, regardless of whether contact information is imported from a member virtual identity or to a member virtual identity from another source, the present invention contemplates that cell phone numbers will be identified as cell phone numbers and fax numbers will be identified as fax numbers, and so forth. It is therefore understood that the present invention contemplates that formatting across file formats will not prevent accurate importation or transfer of contact information.

The examples above focus on the word processor tool, but the examples also apply to the email tool, the spreadsheet tool, the presentation tool, and other software applications, and such uses are contemplated by and included within the scope of the present invention.

Other details and aspects of the member virtual identity to software application contact information importation tool, including but not limited to those relating to importation of contact information and mail merge, are thoroughly disclosed in the prior art, and these disclosures are incorporated herein by reference.

It is to be understood that other embodiments may be utilized and functional changes may be made without departing from the scope of the present invention. The foregoing descriptions of the embodiments of the invention have been presented for the purposes of illustration and description. They are not intended to be exhaustive or to limit the invention to the precise forms disclosed unless specifically noted as so limiting. Accordingly, many modifications and variations are possible in light of the above teachings.

For example, a user or member may include different sets of information to be included in his or her member profile than are described here. As a practical example, a medical professional may choose to include an affiliation with a hospital or care center, or with a particular research group. As another example, a user may create a particular member profile to be shared with members or communities in his or her profession, and a different member profile (or set of information from the member profile) to be shared with members from his or her church, political group, or community of friends (a rec league softball team, for example).

It is intended that these additional fields of information to be included in the user's member profile would also be within the scope of the invention, even though it is not otherwise spelled out in the specification. It is therefore intended that the scope of the invention not be limited by this detailed description.

### DETAILED DESCRIPTION OF THE CLAIMED INVENTION AS SHOWN IN ADDITIONAL FIGURES

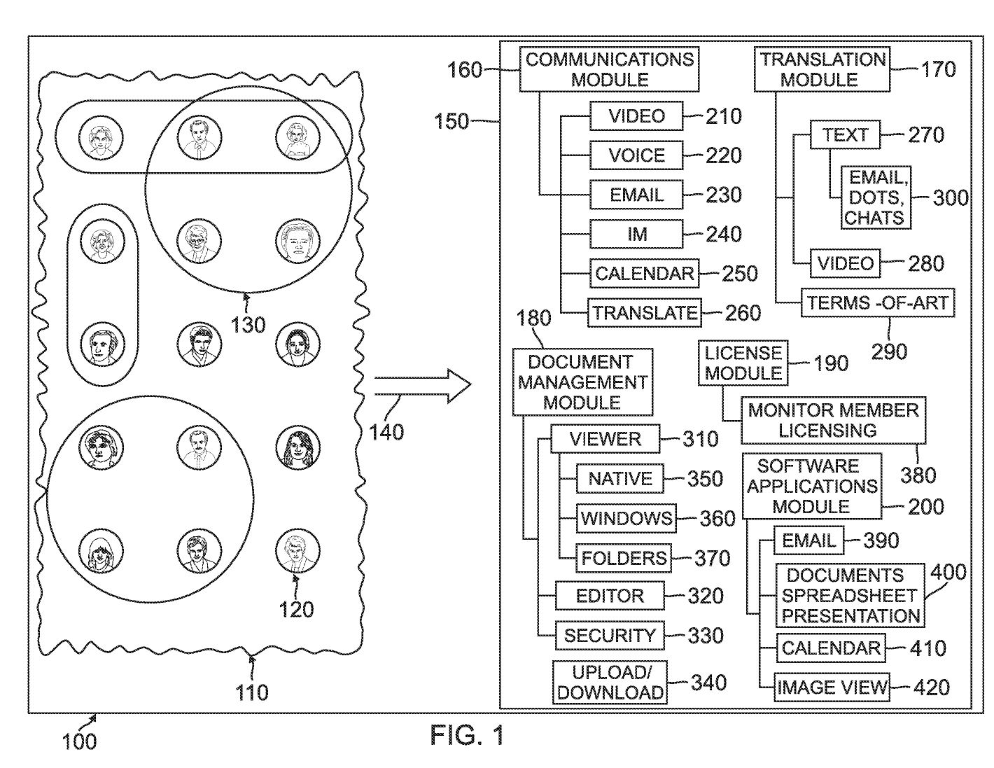

FIG. 1 shows a secure, network-based collaborative work environment 100 according to the present invention. The secure, network-based collaborative work environment 100 allows one or members 120 of an online community 110 to access and utilize several integrative functionalities 150 as fully described herein. The one or more members may be grouped together into one or more networks of members 130.

Members 120 of the online community 110 have an account with the online community 110 which defines a member virtual identity 640 associated with the member 120. The member's account and virtual identity 640 form a member profile which conveys information about the member 120. The member virtual identity 640 is an online representation of that member 120 and may take many different forms. For example, a member's 120 webpage or collection of web pages may be considered a member virtual identity 640. The member virtual identity 640 may be represented by an icon.

A network 130 within the online community 110 may also have an account with the online community 110 which defines a network virtual identity 650 associated with the network 130. The network's account and virtual identity 640 form a network profile which conveys information about the network 130. The network virtual identity 650 is an online representation of that network 130, may take many different forms, and like a member virtual identity 640, may be represented by an icon. Also like the member virtual identity 640, a network 130 may be represented by a webpage or collection of web pages that may be considered a network virtual identity 650.

The secure, network-based collaborative work environment 100 and online community 110 are available and accessible to the one or more members 120 via a portal 140 to the “cloud” in a computing environment. The secure, network-based collaborative work environment 100 and online community 110 are therefore resident in a server-based architecture in the “cloud” in which the portal 140 allows the one or more members 120 to collaborate with one another. The present invention therefore contemplates that the secure, network-based collaborative work environment 100 and online community 110 are an extension of cloud computing in which a plurality of integrative functionalities 150 are accessible to the one or more members 120 as an overlay of collaborative networking and collaborating tools.

The plurality of integrative functionalities 150 available to the one or more members 120 includes at least a communications module 160, a translation module 170, a document management module 180, and a software applications module 200. At least one additional integrative functionality 150 includes a license module 190 which controls monitoring of licensing of the one or more members 120. License module 190 further includes a sub-module 380 for performing the task of license monitoring. Each of these integrative functionalities 150 include several sub-modules for executing various algorithms associated with the integrative functionalities 150 and allow the one or more members 120 to perform different tasks within the online community 110.

The communications module 160 of the integrative functionalities 150 includes sub-modules for video conferencing 210, voice conferencing 220, email 230, various forms of instant messaging 240, calendaring 250, and translation 260. The translation module 170 of the integrative functionalities 150 includes a text sub-module 270 that further includes capabilities for translating emails, documents, and chats 300. Translation module 170 also includes a video translation sub-module 280 and a terms-of-art translation sub-module 290.

The document management module 180 includes several sub-modules designed to facilitate collaboration amongst members 120 who are working with various documents. The document management module 180 includes a viewer sub-module 310 that has further sub-modules that enable the viewing of native documents 350, provide various options for windows management 360, and various options for folder management 370. The document management module 180 also includes an editor sub-module 320 and a security sub-module 330. Addition sub-modules for the document management sub-module 180 include an upload/download sub-module 340 that manages the upload and download of documents within the online community 110.

The software applications module 200 includes several sub-modules offering software applications to the one or more members 120. Each of these sub-modules allows the one or more members 120 to conduct various activities within the online community 110. For example, the software applications module 200 includes an email sub-module 390 which allows a member 120 to access email applications for managing, sending, receiving, deleting, storing, and aggregating email. The document, spreadsheet, and presentation sub-module 400 allows a member 120 to access one or more applications for word processing, spreadsheeting, and preparing presentations. A calendar sub-module 410 allows access to applications for maintaining a calendar of important dates and meetings. Many additional applications sub-modules are contemplated with the present invention. Another such sub-module may be an image viewing sub-module 420 which allows a member 120 to easily view documents with a number of different applications for viewing different kinds of documents, particularly in connection with the document, spreadsheet, and presentation sub-module 400. Note that the image viewing sub-module 420 may be different than the viewer sub-module 310 associated with the document management module 180.

It is to be noted that many different applications are contemplated for the email sub-module 390, the document, spreadsheet, and presentation sub-module 400, the calendar sub-module 410, the image viewing sub-module 420, and the other applications sub-modules contemplated by the present invention.

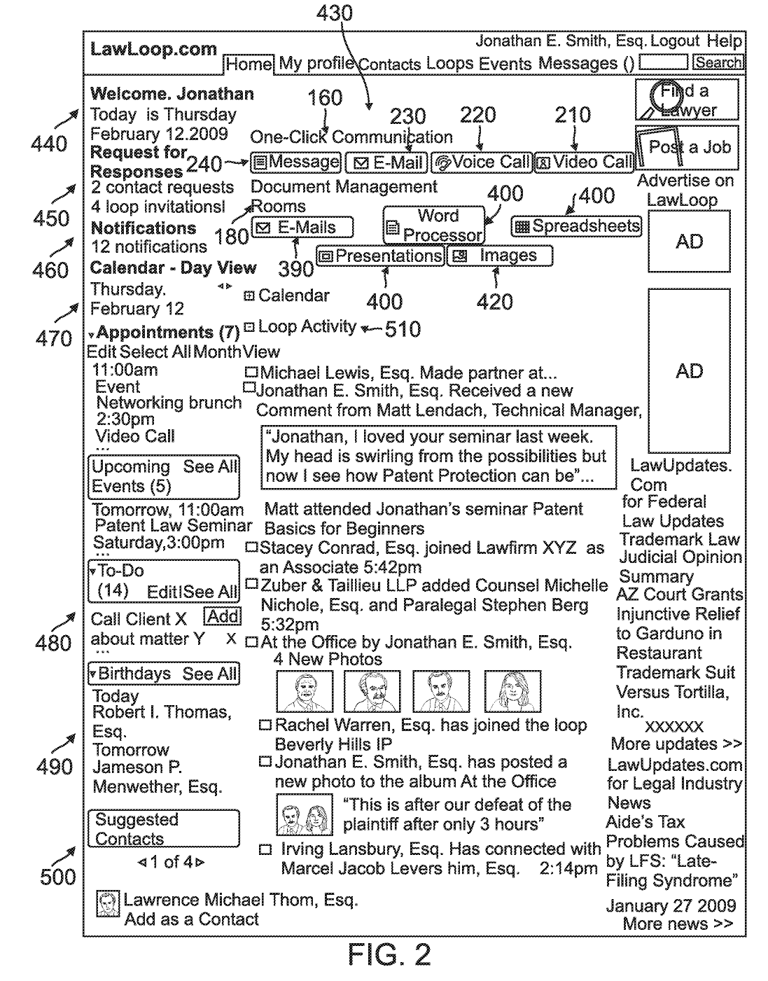

FIG. 2 shows an exemplary graphical implementation of one aspect of the present invention. In FIG. 2, a member's 120 home page on the graphical user interface 140 is depicted. The member's 120 home page 430 of the online community 110 on the graphical user interface 140 shows one embodiment of several integrative functionalities 150 accessible to the member 120.

At the home page of the online community 110 on the graphical user interface 140, integrative functionalities such as the communications module 160 and document management module 180 are shown. In this embodiment, the communications module 160 has sub-modules 210, 220, 230 and 240 available as one-click options for a member 120. Each of these one click options are available to the member 120 as “buttons” on the graphical user interface 140.

FIG. 2 also shows sub-modules of the document management module 180 available as “buttons” on the graphical user interface 140. A member 120 may click on the “button” on the graphical user interface 140 for any sub-module. In FIG. 2, sub-modules 390, 400, and 420 are shown. Some sub-modules may have more than one “button.” For example, in FIG. 2, a member may click on a different part of the graphical user interface 140 for the sub-module 400 for word processing, the sub-module 400 for spreadsheets, and the sub-module 400 for presentations.

FIG. 2 also shows other information available to a member 120 at the home page 430 of the online community 110. The present invention contemplates that many different types of information can be depicted on the home page 430 of the online community 110, and therefore this description of exemplary information provided is not intended to be exhaustive or to limit the invention to the precise forms disclosed. Information presented may include a virtual member identity 440, a request for responses section 450, and a notifications section 460. Other information presented may include a calendar section 470 and to-do section 480. A birthdays section 490 and a suggested contacts section 500 may also be included. Different views of any of these types of information may also be provided. For example, calendar section 470 may be provided in a day view, a monthly view, in a weekly view, or any other type of calendar view. Drop-down or drop-across menus may also be accessible to select from different views and further information available within any of these sections of information. Members 120 may also be able to click on any information listed on the home page 430 and go to a different screen providing further information about what was just clicked on.

Other types of information available in FIG. 2 include loop activity 510. As with other types of information described above, a member 120 may click on any sub-information section listed under loop activity 510 and enter into a loop 520.

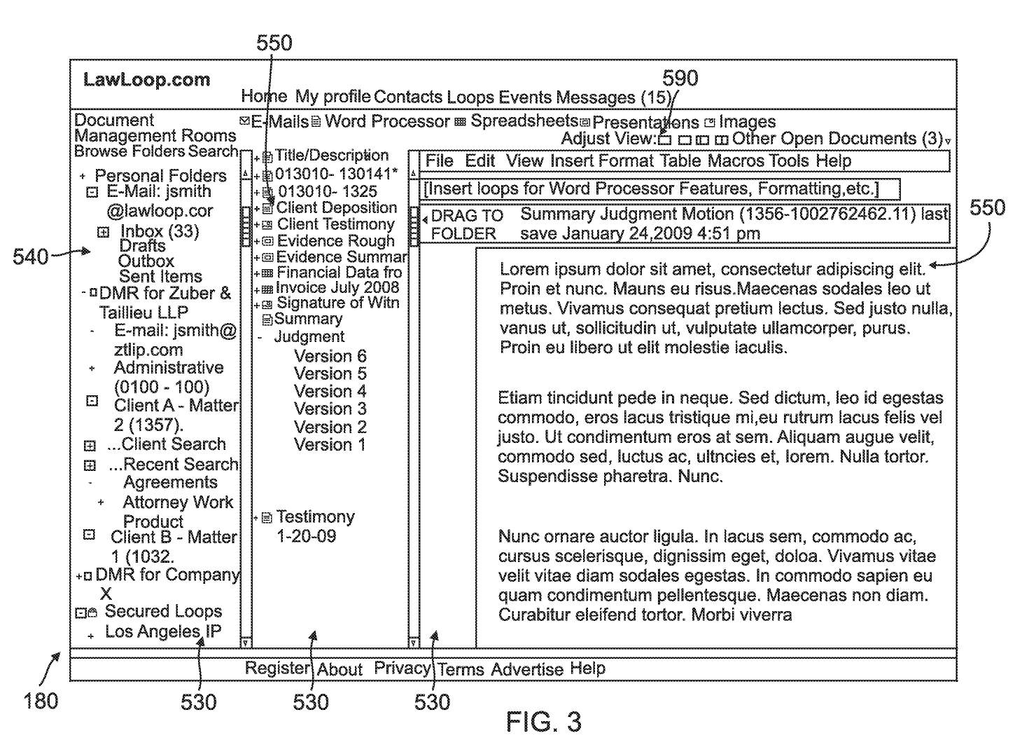

FIG. 3 shows an exemplary graphical implementation of another aspect of the present invention showing multiple windows 530 of a document management module 180. In FIG. 3, document management module 180 is divided into a folder window 530 showing multiple folders 540 as managed by the viewer sub-module 310, windows sub-module 360, and folders viewer sub-module 370. FIG. 3 also shows a document window 530 showing multiple documents 550 within a particular folder 540 as managed by the viewer sub-module 310, windows sub-module 360, and folders viewer sub-module 370. A viewer 590 in window 530 shows a document 550 selected from the list of documents 550.

The document management module 180 of the integrative functionalities 150 provides members 120 with several features for working with, editing, manipulating, and managing documents. Within the larger context of collaboration within a secure loop in the online community 110, members 120 and groups or networks of members 130 can come together with the present invention and work with documents using one or more of the integrative functionalities 150. Actions that a member 120 may take using the document management module 180 include clicking on an icon on a member virtual identity 640 existing in the context of the online community 110 and thereby giving the member 120 associated with such member virtual identity 640 access to (or retracting access of the member 120 associated with such member virtual identity 640 to) a document management room shared by a network that at least some members 120 associated with member virtual identities 640 do not have access to. Other actions include dragging a document stored in a first folder containing documents shared by members of a first network of members 130 (and not shared with members 120 not of said first network 130) to a second folder containing documents shared by members of a second network 130 (and not shared with members 120 not of said second network 130), such that the document is shared with members of the first network 130 and members of the second network 130, wherein at least one of said members of said second network 130 is not also a member 120 of said first network 130.

Still other actions include dragging a document stored in a first folder containing documents shared by members of a first network of members 120 (and not shared with members 120 not of said first network 130) to a second folder containing documents shared by members of a second network 130 (and not shared with members 120 not of said second network 130), such that the document is shared with members of the first network 130 and members of the second network 130, and such that the document appears on the second network virtual identity 650 page (e.g.: the Secure Loop Profile page), wherein at least one of said members of said second network 130 is not also a member 120 of said first network 130.

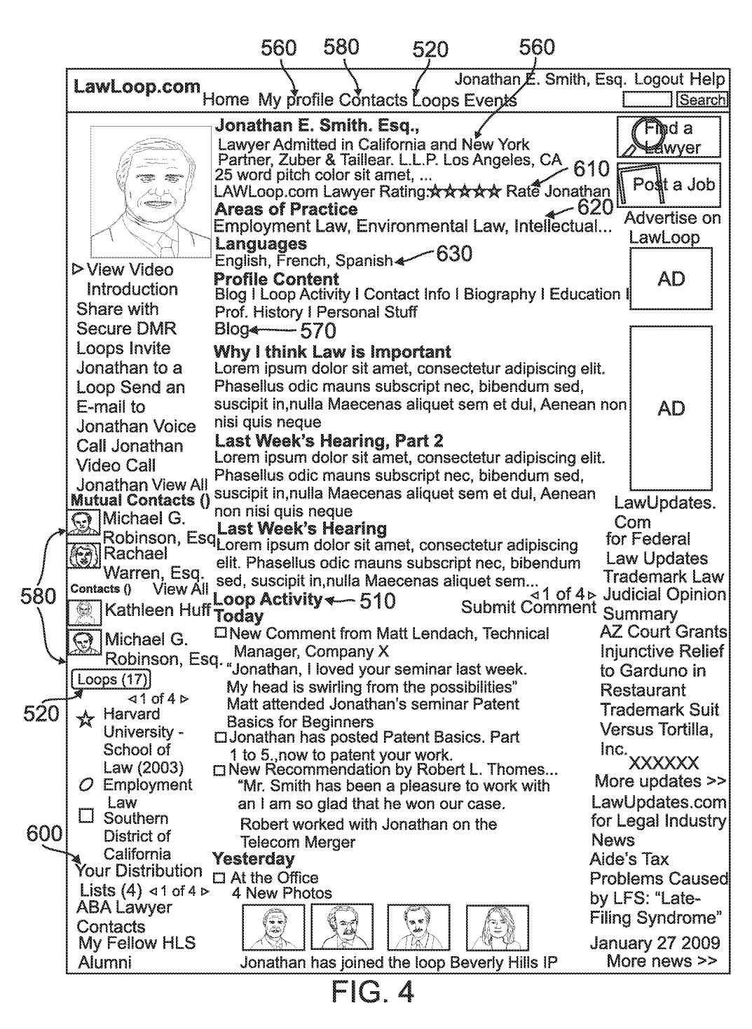

FIG. 4 is an exemplary graphical implementation of another aspect of the present invention showing a profile page 560 of a member 120. The profile page 560 of a member 120 shows various information about the member represented by the member's virtual identity 640, including areas of practice 620, languages 630, a lawyer rating 610, a blog section 570, and loop activity 510. The profile page 560 may also show a contact file management tool 580, loops 520, and distribution lists 600. Links may be provided to content such as the profile page 560 itself, the contact file management tool 580, loops 520, or any other content available to members 120 of the online community 110. Clicking on an icon representative of the member virtual identity 640 displays the information on the profile page 560. A member's 120 contacts 660 may be represented by an icon, and another member 120, regardless of network 130 membership, may simply import his or her contact information by clicking on the icon and dragging it to his or her contacts section of the member virtual identity 640.

The contact file management tool 580 is an integrative functionality 150 that may include files (i.e.: like Outlook® contact files) which consist of contact information imported from at least one of other member virtual identity 640. Allowing importation of a member's 120 contacts 660 from another member's 120 member virtual identity 640 eliminates the need to get someone's business card and have a secretary or assistant add their information to new Outlook® contact file. Therefore, with this integrative functionality 150 of the present invention, one can very simply add contacts from a member's virtual identity 640, and a contact file will be created automatically.

The contact file management tool 580 is a powerful tool for allowing members 120 to easily import contacts 660 from other members' member virtual identities 640. It also allows members 120 to quickly share contacts 660 with each other and within networks, and quickly and seamlessly import and export contacts 660 from third party applications. Therefore, the contact file management tool 580 is configured to integrate one's contacts from multiple sources, and to integrate new contacts 660 therein. The contact file management tool 580 is also configure to adhere to members 120 excluded from certain networks, so that certain members 120 do not have access to other members' 120 contact information.

1. A method for interactively collaborating within a secure, server-based social networking community, comprising:
members, each of a plurality of the members owning at least one social networking member profile, wherein the member profile contains contact information relating to the owner of the member profile;
at least one network of social networking member profiles that excludes a social networking member profile of at least one member of the community, whereby members owning social networking member profiles belonging to said at least one network share access to a secure pool of contact profiles, such that members not owning social networking member profiles belonging to said at least one network do not have access to the pool of contact profiles, whereby members owning social networking member profiles belonging to said at least one network share access to a secure pool of contact files, such that members not owning social networking member profiles belonging to said at least one network do not have access to the pool of contact files, and whereby members owning social networking member profiles belonging to said at least one network share access to a secure set of documents, such that members not owning social networking member profiles belonging to said at least one network do not have access to the secure set of documents;
a document management tool comprised of at least one software application chosen from a group consisting of a document filing application, a word processor application and a spreadsheet application, whereby the document management tool enables members owning social networking member profiles belonging to said at least one network to remotely manage documents of the secure set of documents.

2. The method of claim 1, wherein contact information from at least one of the member profiles is imported into a document edited by the at least one software application.

3. The method of claim 1, wherein the social networking community enables a member owning a social networking member profile belonging to said at least one network to add a contact profile of the member to the pool of contact profiles shared by said at least one network.

4. The method of claim 1, wherein the social networking community enables a member owning a social networking member profile belonging to said at least one network to add a contact file of the member to the pool of contact files shared by said at least one network.

5. The method of claim 1, wherein the social networking community prevents duplicate contact profiles from being added to the pool of contact profiles and wherein the social networking community prevents duplicate contact files from being added to the pool of contact files.

6. The method of claim 1, wherein the social networking community alerts a member owning a social networking member profile belonging to said at least one network that a member is attempting to add a contact profile to the pool of contact profiles that corresponds to the same member as a contact profile already existing in the pool of contact profiles or has a name that matches the name of a contact file already existing in the pool of contact files.

7. The method of claim 1, wherein the social networking community alerts a member owning a social networking member profile belonging to said at least one network that a member is attempting to add a contact file to the pool of contact files that has a name that matches the name of a contact profile already existing in the pool of contact profiles or the name of a contact file already existing in the pool of contact files.

8. The method of claim 1, wherein the social networking community alerts a first member owning a social networking member profile belonging to said at least one network that a member is attempting to add a first contact profile to the pool of contact profiles that corresponds to the same second member as a second contact profile already existing in the pool of contact profiles or has a name that matches the name of a contact file already existing in the pool of contact files, wherein the first member is then enabled to choose at least one action chosen from a group consisting of:
a) not adding the first contact profile to the pool of contact profiles;
b) not adding the first contact profile to the pool of contact profiles, but supplementing the second contact profile with non-superfluous information from the first contact profile;
c) adding the first contact profile to the pool of contact profiles, and supplementing the first contact profile with non-superfluous information from the second contact profile;
d) adding the first contact profile to the pool of contact profiles, and supplementing the first contact profile with information from the contact file; and
e) adding the first contact profile to the pool of contact profiles.

9. The method of claim 1, wherein the social networking community alerts a member owning a social networking member profile belonging to said at least one network that a member is attempting to add a first contact file to the pool of contact files that has a name that matches the name of a contact profile already existing in the pool of contact profiles or the name of a second contact file already existing in the pool of contact files, wherein the member is then enabled to choose at least one action chosen from a group consisting of:
a) not adding the contact file to the pool of contact files;
b) supplementing the contact profile with non-superfluous information from the first contact file;
c) not adding the contact file to the pool of contact files, but supplementing the second contact file with non-superfluous information from the first contact file;
d) adding the first contact file to the pool of contact profiles, and supplementing the first contact file with non-superfluous information from the second contact file; and
e) adding the first contact file to the pool of contact files.

10. The method of claim 1, wherein a contact file corresponding to a first member owning a social networking member profile corresponding to a contact profile among the pool of contact profiles is supplemented with information of the contact profile.

11. The method of claim 1, wherein termination of the first member's last friendship with other members of said at least one network causes a contact file corresponding to a first member owning a social networking member profile corresponding to a contact profile among the pool of contact profiles to be created, wherein the contact file contains information from the contact profile.

12. The method of claim 1, wherein a network administrator of said at least one network has the ability to limit access to the pool of contact profiles by a member of said at least one network such that the member does not have access to at least one contact profile of the pool of contact profiles, wherein at least one other member of said at least one network has access to the at least one contact profile.

13. The method of claim 1, wherein a network administrator of said at least one network has the ability to limit access to the information on a contact file of the pool of contact profiles by a member of said at least one network such that the member does not have access to a portion of the information of the contact profile, wherein at least one other member of said at least one network has access to the portion of the information.

14. A method for interactively collaborating within a secure, server-based social networking community, comprising:
members, each of a plurality of the members owning at least one social networking member profile, wherein the member profile contains contact information relating to the owner of the member profile;
at least one network of social networking member profiles that excludes a social networking member profile of at least one member of the community, whereby members owning social networking member profiles belonging to said at least one network share access to a secure pool of contact profiles, such that members not owning social networking member profiles belonging to said at least one network do not have access to the pool of contact profiles, and whereby members owning social networking member profiles belonging to said at least one network share access to a secure set of documents, such that members not owning social networking member profiles belonging to said at least one network do not have access to the secure set of documents;
a document management tool comprised of at least one software application chosen from a group consisting of a document filing application, a word processor application and a spreadsheet application, whereby the document management tool enables members owning social networking member profiles belonging to said at least one network to remotely manage documents of the secure set of documents.

15. The method of claim 14, wherein contact information from at least one of the member profiles is imported into a document edited by the at least one software application.

16. The method of claim 14, wherein the social networking community enables a member owning a social networking member profile belonging to said at least one network to add a contact profile of the member to the pool of contact profiles shared by said at least one network.

17. The method of claim 14, wherein the social networking community prevents duplicate contact profiles from being added to the pool of contact profiles.

18. The method of claim 14, wherein an attempt to add a first contact profile to the pool of contact profiles that corresponds to the same member as a second contact profile already existing in the pool of contact profiles causes the social networking community to perform at least one action chosen from a group consisting of:
a) supplementing the first contact profile with non-superfluous information from the second contact profile;
b) supplementing the second contact profile with non-superfluous information from the first contact profile; and
c) creating a new contact profile that combines information from the first contact profile and the second contact profile.

19. The method of claim 14, wherein the social networking community alerts a first member owning a social networking member profile belonging to said at least one network that a member is attempting to add a contact profile to the pool of contact profiles that corresponds to the same second member as a contact profile already existing in the pool of contact profiles.

20. The method of claim 14, wherein the social networking community alerts a first member owning a social networking member profile belonging to said at least one network that a member is attempting to add a first contact profile to the pool of contact profiles that corresponds to the same second member as a second contact profile already existing in the pool of contact profiles, wherein the first member is then enabled to choose at least one action chosen from a group consisting of:
a) not adding the first contact profile to the pool of contact profiles;
b) not adding the first contact profile to the pool of contact profiles, and supplementing the second contact profile with non-superfluous information from the first contact profile;
c) adding the first contact profile to the pool of contact profiles, supplementing the first contact profile with non-superfluous information from the second contact profile, and deleting the second contact profile from the pool of contact profiles;
d) adding the first contact profile to the pool of contact profiles, and deleting the second contact profile from the pool of contact profiles;
e) creating a new contact profile that combines information from the first contact profile and the second contact profile, adding the new contact profile to the pool of contact profiles, and deleting the first contact profile and the second contact profile from the pool of contact profiles; and
f) adding the first contact profile to the pool of contact profiles.
